(19) United States
(12) Patent Application Publication
(10) Pub. No.: US 2015/0163291 A1
(43) Pub. Date: Jun. 11, 2015

(54) DATA PROCESSING SYSTEM, DEVICE AND METHOD OF DATA PROCESSING

(71) Applicant: Junichi FUKASAKA, Tokyo (JP)

(72) Inventor: Junichi FUKASAKA, Tokyo (JP)

(73) Assignee: RICOH COMPANY, LTD., Tokyo (JP)

(21) Appl. No.: 14/561,288

(22) Filed: Dec. 5, 2014

(30) Foreign Application Priority Data
Dec. 9, 2013 (JP) 2013-253843

(51) Int. Cl. H04L 29/08

(52) U.S. Cl. CPC H04L 67/10

(57) ABSTRACT

A data processing system connected to a device via a network, includes a first replying unit that replies to the device, in response to an obtaining request of screen information from the device before a user is specified, with screen information that is not in correspondence with a specific user among a plurality of screen information that are in correspondence with identification information of the device; and a second replying unit that replies to the device, in response to an obtaining request of screen information from the device after a user is specified, with screen information that is in correspondence with a specified user among the plurality of screen information that are in correspondence with the identification information of the device.

### CROSS-REFERENCE TO RELATED APPLICATION

The present application is based on and claims the benefit of priority of Japanese Priority Application No. 2013-253843 filed on Dec. 9, 2013, the entire contents of which are hereby incorporated by reference.

### BACKGROUND OF THE INVENTION

1. Field of the Invention

The present invention relates to a data processing system, a device and a method of data processing.

2. Description of the Related Art

Recently, without executing an application program on a data processing apparatus that is directly operated by a user, a configuration of providing a service has been spread in which software provided on a network such as the INTERNET or the like is used. For such a configuration of providing a service, a cloud service is known.

It is preferable that screen information of a screen related to a service provided via a network is managed by a service providing side (at a cloud side, for example). If the screen information is managed at the service providing side, it is unnecessary for each client device to previously install the screen information. Further, in such a case, the same screen information can be easily used by each client device.

However, when the screen information is managed by the service providing side, it is necessary for each of the client devices to download the screen information via the network at any timing. When the screen information is capable of being customized to each user, it is not economical to download the screen information of all of the users in a single client device in view of consumption of resources of the client device such as a storage device or the like, a network load or the like. In particular, when a large number of users exist, such as for a company with a large number of employees, it is estimated that the network load, the amount of consumption of the storage device or the like that is necessary in downloading the screen information of all of the users becomes too large so that it cannot be ignored.

### Patent Document

[Patent Document 1] Japanese Laid-open Patent Publication No. 2008-040529

### SUMMARY OF THE INVENTION

The present invention is made in light of the above problems, and improves efficiency regarding obtaining screen information via a network.

According to an embodiment, there is provided a data processing system connected to a device via a network including a first replying unit that replies to the device, in response to an obtaining request of screen information from the device before a user is specified, with screen information that is not in correspondence with a specific user among a plurality of screen information that are in correspondence with identification information of the device; and a second replying unit that replies to the device, in response to an obtaining request of screen information from the device after a user is specified, with screen information that is in correspondence with a specified user among the plurality of screen information that are in correspondence with the identification information of the device.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a view illustrating an example of a structure of a data processing system of an embodiment;

FIG. 2 is a view illustrating an example of a hardware structure of a service providing apparatus of the embodiment;

FIG. 3 is a view illustrating an example of a hardware structure of a device of the embodiment;

FIG. 4 is a view illustrating an example of a functional structure of the service providing apparatus of the embodiment;

FIG. 5 is a view illustrating an example of a functional structure of the device of the embodiment;

FIG. 6 is a view for explaining an example of process steps that are performed in accordance with a preparatory work;

FIG. 7 is a view illustrating a transition example of screens that are displayed at an administrator terminal when the preparatory work is performed;

FIG. 8 is a view illustrating an example of a structure of a user information storing unit;

FIG. 9 is a view illustrating a description example of device information in a device information file;

FIG. 10 is a view illustrating an example of a structure of the device information storing unit;

FIG. 11 is a view illustrating a transition example of screens for registering account information of an online storage system of a cooperating storage;

FIG. 12 is a view illustrating a description example of user information in a user information file;

FIG. 13 is a view for explaining a conceptual model of a profile;

FIG. 14 is a view for explaining an example of a relationship between a profile, a group and a project, and a user;

FIG. 15 is a view illustrating a definition example of a screen information file;

FIG. 16 is a view illustrating a display example of a profile editing screen;

FIG. 17 is a view for explaining information stored in a profile storing unit;

FIG. 18 is a view illustrating a display example of a profile device setting screen;

FIG. 19 is a view illustrating an example of a structure of a profile device correspondence storing unit;

FIG. 20 is a sequence diagram for explaining an example of process steps when using a Scan To Storage service;

FIG. 21 is a sequence diagram for explaining an example of process steps when using the Scan To Storage service;

FIG. 22 is a first display example of an operation screen of a scan device application;

FIG. 23 is a second display example of the operation screen of the scan device application;

FIG. 24 is a flowchart for explaining an example of process steps that are performed when generating a screen based on a screen information file; and

FIG. 25 is a view illustrating an example of management information stored in a management file.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

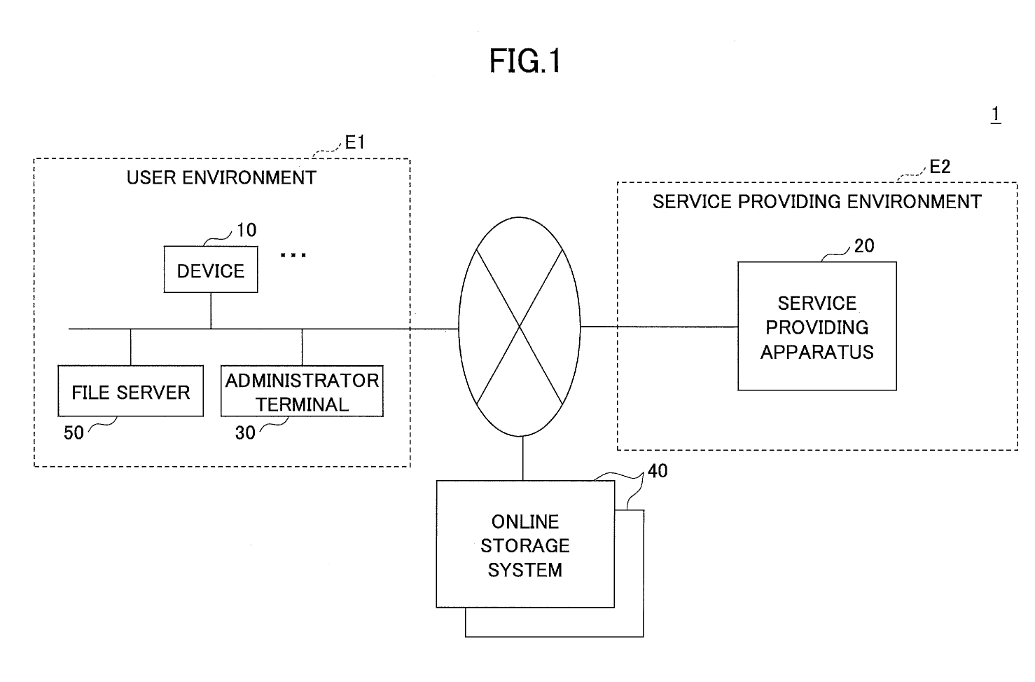

In a data processing system 1 illustrated in FIG. 1, a service providing environment E2, a user environment E1, an online storage system 40 and the like are capable of communicating with each other via a wide area network such as the INTERNET or the like.

The service providing environment E2 is a system environment at an organization that provides a cloud service via the network. Here, although the cloud service is exemplified as a specific example in this embodiment, the present embodiment may be applied to a service provided via a network such as a service provided by an Application Service Provider (ASP), a web service or the like.

The service providing environment E2 includes a service providing apparatus 20. The service providing apparatus 20 provides a predetermined service via the network. One of the services provided by the service providing apparatus 20 is a “Scan To Storage service”. In this embodiment, the Scan To Storage service is explained. The Scan To Storage service means a service of storing image data scanned at a device 10 of the user environment E1 to a previously set storage. Here, alternatively, the service providing apparatus 20 may be provided at the user environment E1. This means that the service providing environment E2 may be included in the user environment E1.

The user environment E1 is a system environment at an organization such as a user company or the like of the device 10. In the user environment E1, one or more of the device 10, an administrator terminal 30, a file server 50 and the like are connected with each other via a network such as a Local Area Network (LAN) or the like.

The device 10 of the embodiment is an image forming apparatus including a scan function. A multifunction peripheral may be used as the device 10 that includes other functions such as printing, copying, facsimile communication (FAX) or the like, in addition to the scan function.

The administrator terminal 30 is used by an administrator of the device 10 in the user environment E1. As an example of the administrator terminal 30, a Personal Computer (PC), a Personal Digital Assistance (PDA), a tablet-type device, a smartphone, a mobile phone or the like may be used.

The file server 50 can be a candidate of the storage to store the image data in the Scan To Storage service in addition to the online storage system 40.

The online storage system 40 provides a cloud service that is a so-called online storage via the network. The online storage is a service to lend out a memory area of the storage. In this embodiment, the memory area lent out by the online storage is a candidate of the storage to store the image data in the Scan To Storage service provided by the service providing apparatus 20.

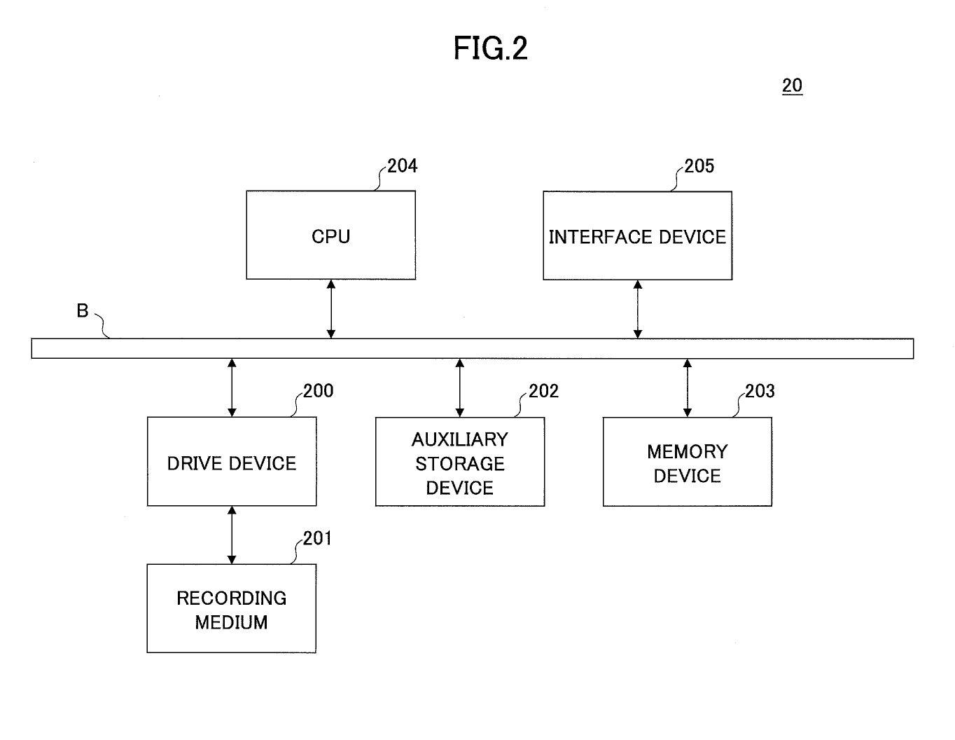

FIG. 2 is a view illustrating an example of a hardware structure of the service providing apparatus 20 of the embodiment. The service providing apparatus 20 illustrated in FIG. 2 includes a drive device 200, an auxiliary storage device 202, a memory device 203, a CPU 204 and an interface device 205 that are connected with each other via a bus B.

A program that actualizes processes of the service providing apparatus 20 is provided by a recording medium 201 such as a CD-ROM or the like. When the recording medium 201 that stores the program is set in the drive device 200, the program is installed in the auxiliary storage device 202 from the recording medium 201 via the drive device 200. Here, however, the program is not necessarily installed from the recording medium 201 and may be downloaded from another computer via the network. The auxiliary storage device 202 stores the installed program, necessary files, data or the like.

Upon receiving an instruction to activate a program, the memory device 203 reads out the program from the auxiliary storage device 202 and stores the program. The CPU 204 actualizes functions of the service providing apparatus 20 in accordance with the program stored in the memory device 203. The interface device 205 is used as interface for connecting to the network.

The service providing apparatus 20 may be configured by a plurality of computers each including the hardware as illustrated in FIG. 2. This means that the processes performed by the service providing apparatus 20, which will be explained later, may be dispersedly performed by the plurality of computers.

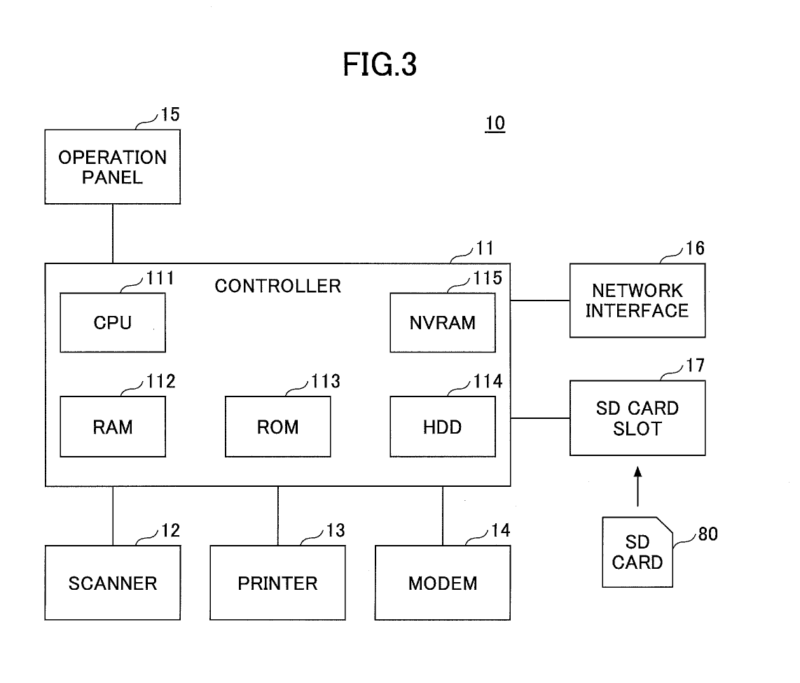

FIG. 3 is a view illustrating an example of a hardware structure of the device 10 of the embodiment. In FIG. 3, the device 10 includes hardware such as a controller 11, a scanner 12, a printer 13, a modem 14, an operation panel 15, a network interface 16, an SD card slot 17 and the like.

The controller 11 includes a CPU 111, a RAM 112, a ROM 113, a HDD 114, a NVRAM 115 and the like. The ROM 113 stores various programs, data used by the programs or the like. The RAM 112 provides a memory area for loading the programs, a work area for the loaded programs or the like. The CPU 111 actualizes the various functions by executing the programs loaded on the RAM 112. The HDD 114 stores various programs, data used by the programs or the like. The NVRAM 115 stores various setting data or the like.

The scanner 12 is hardware (image reading unit) that obtains image data from a document. The printer 13 is hardware (print unit) that prints print data on a print paper. The modem 14 is hardware for connecting to a telephone line and is used for performing sending and receiving image data by a FAX communication. The operation panel 15 is hardware including an input unit for accepting an input from a user such as a button or the like, a display unit such as a liquid crystal panel or the like, or the like. The network interface 16 is hardware for connecting to a network (regardless of wired or wireless) such as LAN or the like. The SD card slot 17 is used for reading out programs stored in an SD card 80. This means that in the device 10, not only the programs stored in the ROM 113, the programs stored in the SD card 80 may be loaded to the RAM 112 and may be executed. Further, the SD card 80 may be substituted by another recording medium (such as a CD-ROM, a Universal Serial Bus (USB) memory or the like, for example). In other words, the kind of recording medium corresponding to the SD card 80 is not limited to a specific recording medium. At this time, the SD card slot 17 may also be substituted by another hardware in accordance with the kind of the recording medium.

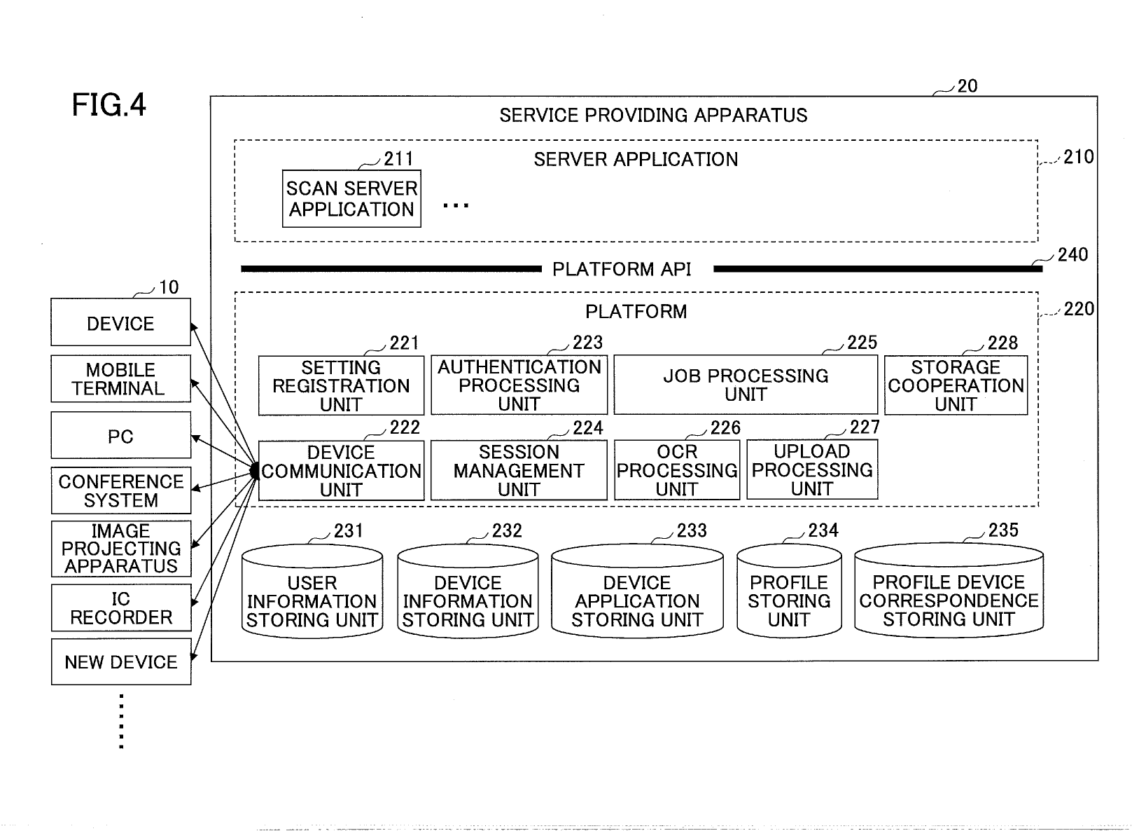

FIG. 4 is a view illustrating an example of a functional structure of the service providing apparatus 20 of the embodiment. In FIG. 4, the service providing apparatus 20 includes software such as a server application 210, a platform 220 and the like. These are composed by one or more program installed in the service providing apparatus 20 and these make the CPU 204 perform predetermined processes.

The service providing apparatus 20 uses a user information storing unit 231, a device information storing unit 232, a device application storing unit 233, a profile storing unit 234, a profile device correspondence storing unit 235 and the like. Each of these storing units can be actualized by the auxiliary storage device 202, a storage device connected to the service providing apparatus 20 via the network or the like.

The server application 210 is an application program that actualizes a service provided by the service providing apparatus 20. Here, the service is not accomplished only by the server application 210. The service is accomplished by a cooperation of the server application 210 and the device 10. Further, there may be a service that is accomplished by cooperation with another cloud service or the like such as an online storage or the like. Here, the term “server application” is used to differentiate an application program at a service providing apparatus 20 side from an application program (scan device application 125, for example, which will be explained later) that needs to be installed at a device 10 side in order to cooperate with the server application 210.

In FIG. 4, the scan server application 211 is illustrated as an example of the server application 210. The scan server application 211 is the server application 210 that performs a process regarding the Scan To Storage service.

The platform 220 includes functions that are common for a plurality of the server applications 210, basic functions used by the plurality of server applications 210 or the like. In FIG. 4, the platform 220 includes a setting registration unit 221, a device communication unit 222, an authentication processing unit 223, a session management unit 224, a job processing unit 225, an OCR processing unit 226, an upload processing unit 227, a storage cooperation unit 228 and the like. Each of these functions is open to the server applications 210 via the platform API 240. In other words, each of the server applications 210 is capable of using these functions within a range that is opened by the platform API 240.

The setting registration unit 221 performs a setting registration process that is necessary when using the service provided by the service providing apparatus 20 such as the Scan To Storage service or the like. The setting registration unit 221 registers information in the user information storing unit 231, in the device information storing unit 232, in the profile storing unit 234 and in the profile device correspondence storing unit 235.

The user information storing unit 231 stores information regarding users of the service provided by the service providing apparatus 20. The device information storing unit 232 stores information regarding the devices 10 that cooperate with the service provided by the service providing apparatus 20 at the system environment of the user (in other words, the user environment E1). In other words, the service provided by the service providing apparatus 20 such as the Scan To Storage service or the like is actualized by the cooperation with each of the devices 10 of the user environment E1.

The device application storing unit 233 stores an application program (hereinafter, referred to as a “device application”) that is necessary to be installed in the device 10 in order to make the server application 210 and the device 10 cooperate with each other. The profile storing unit 234 stores profiles. Each of the profiles includes configuration information of operation screens of the device application, information regarding processes that are performed in accordance with the operation to the operation screens, and the like. The profile device correspondence storing unit 235 stores correspondence data between the profile and the device 10. This means it is possible to correspond different profiles to the operation screens for the same device application for the devices 10, respectively.

The device communication unit 222 controls a communication between the device 10. The authentication processing unit 223 authenticates the user of the administrator terminal 30, the user of the device 10 or the like. Further, the authentication processing unit 223 takes over a log-in process to the online storage system 40 when performing the Scan To Storage service, for example. The session management unit 224 manages session of a communication between the service providing apparatus 20 and the device 10 when they cooperate with each other.

The job processing unit 225 controls performing of the job requested by the server application 210 using the OCR processing unit 226, the upload processing unit 227 or the like, for example. The OCR processing unit 226 performs an OCR process on image data to be processed when the job requested by the server application 210 is the OCR process. The upload processing unit 227 uploads data when the job requested by the server application 210 is to upload the data via the network. Storing data in the online storage system 40 is one of embodiments of uploading.

The storage cooperation unit 228 cooperates with the online storage system 40.

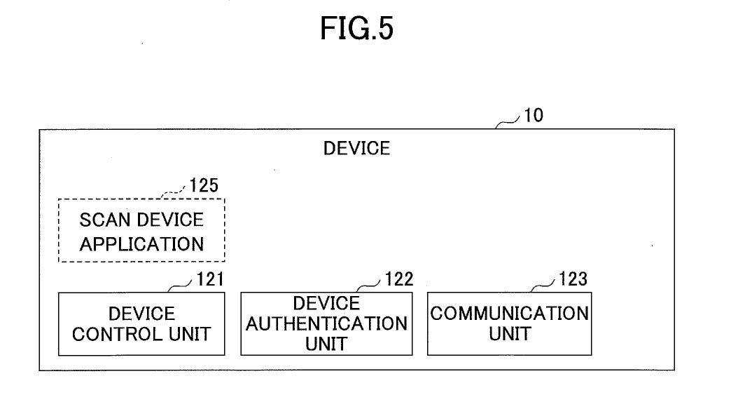

FIG. 5 is a view illustrating an example of a functional structure of the device 10 of the embodiment. In FIG. 5, the device 10 includes a device control unit 121, a device authentication unit 122, a communication unit 123 and the like. Each of the units is actualized by a process executed by the CPU 111 by one or more of the programs installed in the device 10.

The device control unit 121 controls hardware of the device 10. The device authentication unit 122 performs a process to authenticate an operator of the device 10. The communication unit 123 controls a communication via the network.

FIG. 5 illustrates the scan device application 125 by a dashed line. The scan device application 125 is one of device applications, and is installed in the device 10 in order to have the device 10 cooperate with the service providing apparatus 20 in the Scan To Storage service. The device application may be in any form as long as capable of being installed in the device 10, and an application program that is also capable of functioning as the server application may be installed in the device 10 as the device application.

In this embodiment, the scan device application 125 is not previously installed in the device 10, but is installed in the device 10 by a preparatory work that is performed in order to use the Scan To Storage service. Thus, the scan device application 125 is expressed by the dashed line in FIG. 5. However, alternatively, the scan device application 125 may be previously installed in the device 10.

Hereinafter, process steps performed at the data processing system 1 are explained. At the user environment E1, in order to use the Scan To Storage service, it is necessary to perform the preparatory work such as registering various information regarding the user environment E1 to the service providing apparatus 20, introducing the scan device application 125 to the devices 10 and the like. Thus, first, process steps that are performed in accordance with the preparatory work are explained. The preparatory work is performed by an administrator of the device 10 (hereinafter, simply referred to as an “administrator”) at the user environment E1 using the administrator terminal 30.

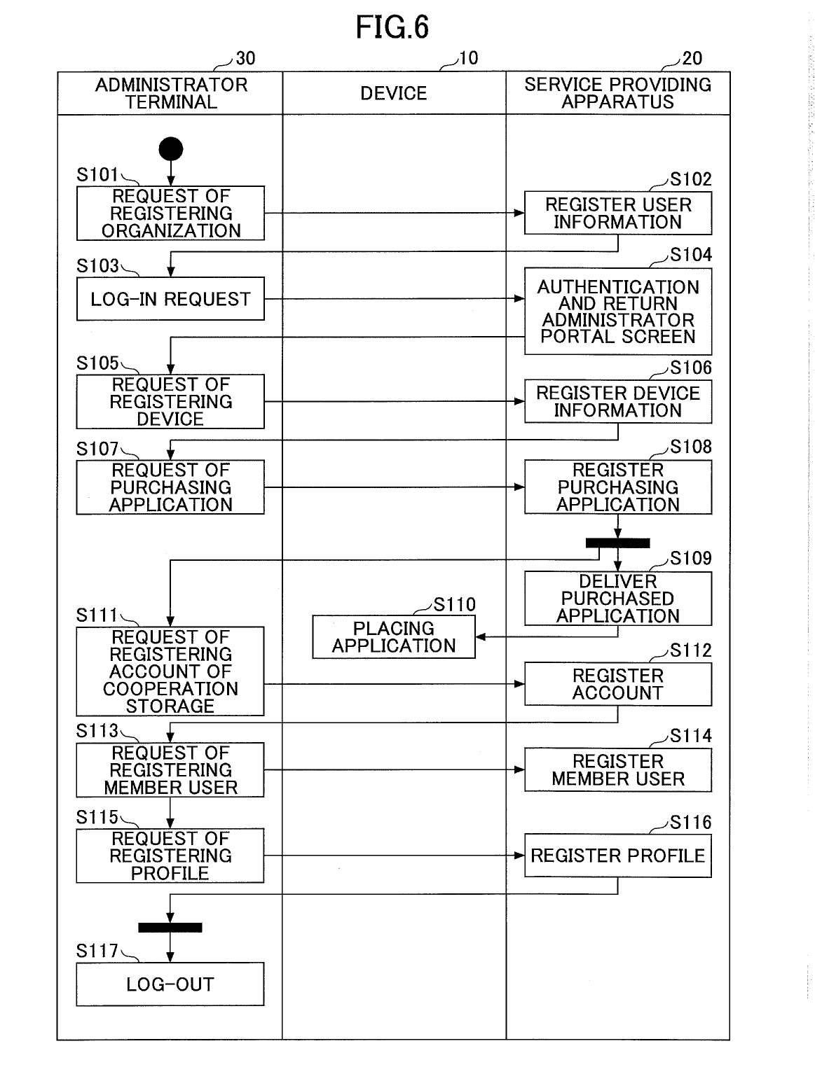

FIG. 6 is a view for explaining an example of process steps performed in accordance with the preparatory work.

In step S101, in accordance with an instruction input by the administrator, the administrator terminal 30 sends an organization registration request to the service providing apparatus 20. The organization registration request means a registration request of information regarding an organization that uses the service provided by the service providing apparatus 20. The instruction of the organization registration request may be input via screens as explained in the following, for example.

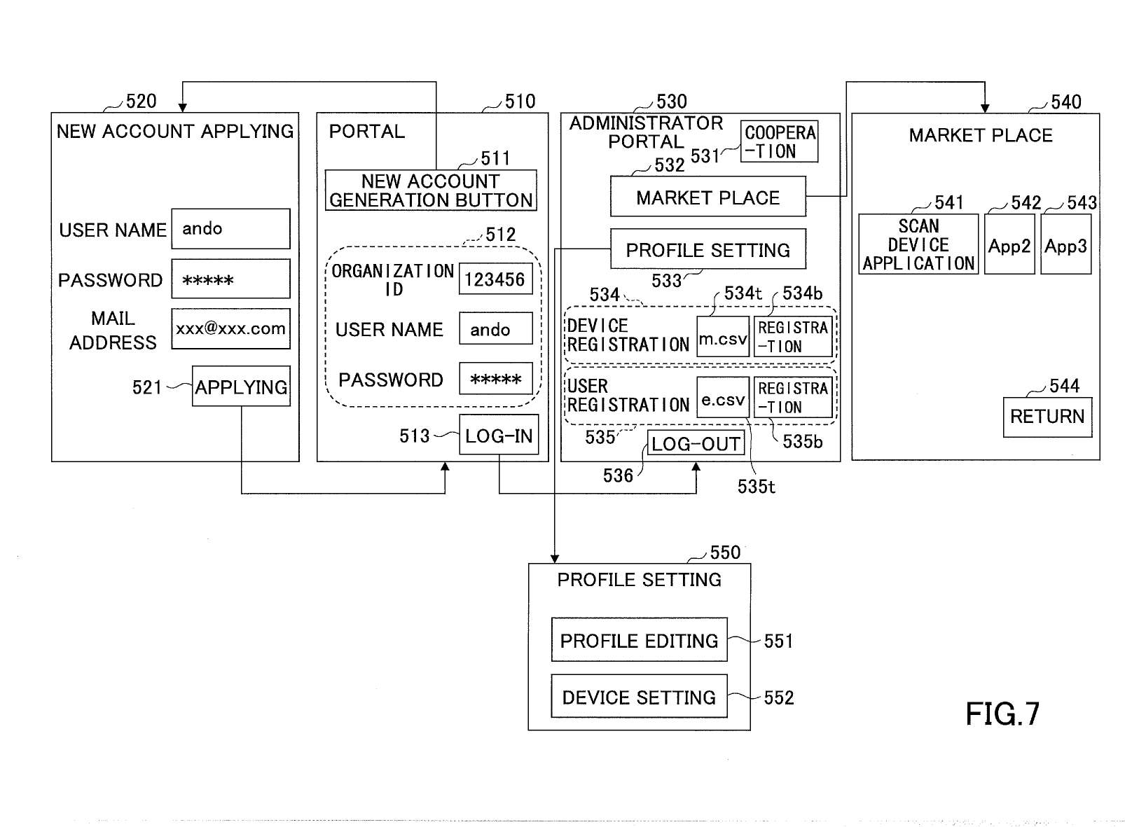

FIG. 7 is a view illustrating a transition example of screens displayed on the administrator terminal 30 during the preparatory work. When starting the preparatory work, a portal screen 510 as illustrated in FIG. 7 is displayed on the administrator terminal 30. The portal screen 510 is a screen to enter the service provided by the service providing apparatus 20. The various screens illustrated in FIG. 7 are displayed based on a Web page including HTML data or the like provided by the service providing apparatus 20, for example. This means that although not explained in the following, when transitioning to each of the screens, a Hyper Text Transfer Protocol (HTTP) communication is performed between the administrator terminal 30 and the service providing apparatus 20.

The portal screen 510 includes a new account generation button 511, a log-in information input area 512, a log-in button 513 and the like.

When registering an organization, the administrator presses the new account generation button 511. When the new account generation button 511 is pressed, a new account applying screen 520 is displayed on the administrator terminal 30. Here, in FIG. 7, an arrow from a button in a screen to another screen indicates that the other screen is displayed by pressing the button.

When a user name, a password and a mail address of the administrator are input and an applying button 521 is pressed in the new account applying screen 520, the administrator terminal 30 sends the organization registration request including the user name, the password, the mail address and the like to the service providing apparatus 20.

In the service providing apparatus 20, upon receiving the organization registration request, the setting registration unit 221 registers the information or the like included in the organization registration request in the user information storing unit 231 (S102).

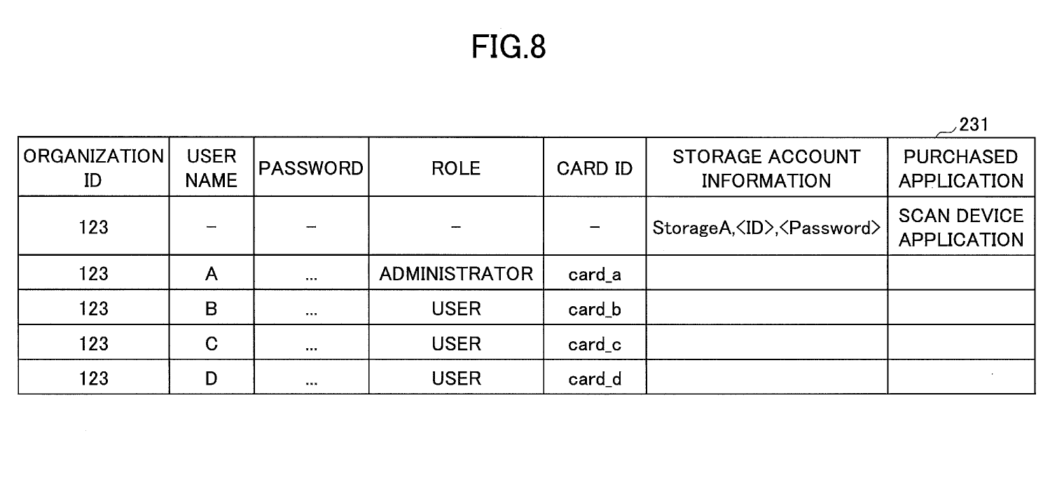

FIG. 8 is a view illustrating an example of a structure of the user information storing unit 231. In FIG. 8, each record of the user information storing unit 231 includes items such as “organization ID”, “user name”, “password”, “role”, “card ID”, “storage account information”, “purchased application” and the like.

The “organization ID” is an identifier that is allocated to each user environment E1, in other words, to each organization such as a company user that uses the service provided by the service providing apparatus 20. The “user name”, the “password”, the “role” and the “card ID” are a user name, a password, a role and card ID of each individual user (hereinafter, referred to as a “member user”) who is a member of the organization of the organization ID.

The “role” is an item to identify an administrator among the member users. This means that for the member user who is the administrator, “administrator” is registered, and for the member user other than the administrator, “user” is registered. The “card ID” is an identifier of an IC card that is used when the member user logs-in the device 10. The “storage account information” is account information of an online storage that is used by the organization of the organization ID. The account information is used as authentication data that is presented to the online storage system 40 when storing the image data scanned at the device 10 in the online storage system 40. The “purchased application” is a list of an identifier (hereinafter, referred to as “application ID”) of an application purchased at the organization of the organization ID. Although the name of the application is illustrated in FIG. 8, for explanation purposes, the application ID may be a string or the like of a numeral, a letter of the alphabet or the like.

In the user information storing unit 231, the record in which a user name is not stored is a record corresponding to the organization (user environment E1) (hereinafter, referred to as an “organization record”). The record in which a user name is stored is a record corresponding to a member user (hereinafter, referred to as a “member record”). Among the member records, the record in which the role is the “administrator” is referred to as an “administrator record” hereinafter. The record in which the role is the “user” is referred to as an “user record” hereinafter. In this embodiment, the items “storage account information” and “purchased application” are effective in the organization record. However, the item “storage account information” may be effective in the member record. For example, the item “storage account information” may be set in the administrator record or may be set for each of the user records.

In step S101, one organization record and one administrator record are generated. Organization ID is stored in the organization record. This means that the organization ID is allocated in accordance with the generation of the organization record. In the administrator record, the organization ID, a user name, a password, a role and the like are registered. For the organization ID of the administrator record, a value same as the organization ID of the generated organization record is registered. For the user name and the password, the user name and the password included in the organization registration request are registered. For the role, “administrator” is registered.

Other items of the organization record and the administrator record, the user records and the like are registered or generated in the following processes, that are explained later.

Subsequently, the setting registration unit 221 sends an e-mail (hereinafter, referred to as “registration notification mail”) notifying that the organization registration is normally performed, for example, to the mail address included in the organization registration request. The registration notification mail includes, for example, the allocated organization ID. Alternatively, the notification that the organization registration is normally performed may be included in a HTTP response to a HTTP request including the organization registration request, for example. Further, alternatively, the organization ID may be designated by a user in the new account applying screen 520.

When the registration of the organization is normally completed, the administrator inputs the registered organization ID, the user name, and the password in the log-in information input area 512 and presses the log-in button 513, of the portal screen 510. In response to pressing of the log-in button 513, the administrator terminal 30 sends the log-in request to the service providing apparatus 20 (S103). The log-in request includes the organization ID, the user name and the password input in the log-in information input area 512.

In response to the log-in request, the authentication processing unit 223 of the service providing apparatus 20 authenticates the user of the log-in request based on whether a record whose value of the role is the “administrator” and including the log-in ID, the user name and the password included in the log-in request is stored in the user information storing unit 231. When the corresponding record is stored, the authentication succeeds (S104). When the corresponding record is not stored, the authentication fails. When the authentication succeeds, the setting registration unit 221 returns a Web page for displaying a portal screen (hereinafter, referred to as an “administrator portal screen 530”) specified for the administrator of the user name included in the log-in request. Hereinafter, the administrator who logs-in is referred to as a “log-in administrator”.

The administrator terminal 30 displays the administrator portal screen 530 based on the returned Web page. As illustrated in FIG. 7, the administrator portal screen 530 includes a cooperation button 531, a market place button 532, a profile setting button 533, a device registration area 534, a user registration area 535 and the like.

Then, the administrator inputs a file name of a file (hereinafter, referred to as a “device information file”) in which information (hereinafter, referred to as “device information”) regarding the devices 10 to cooperate with the Scan To Storage service are described in a text box 534t of the device registration area 534 and presses the registration button 534b.

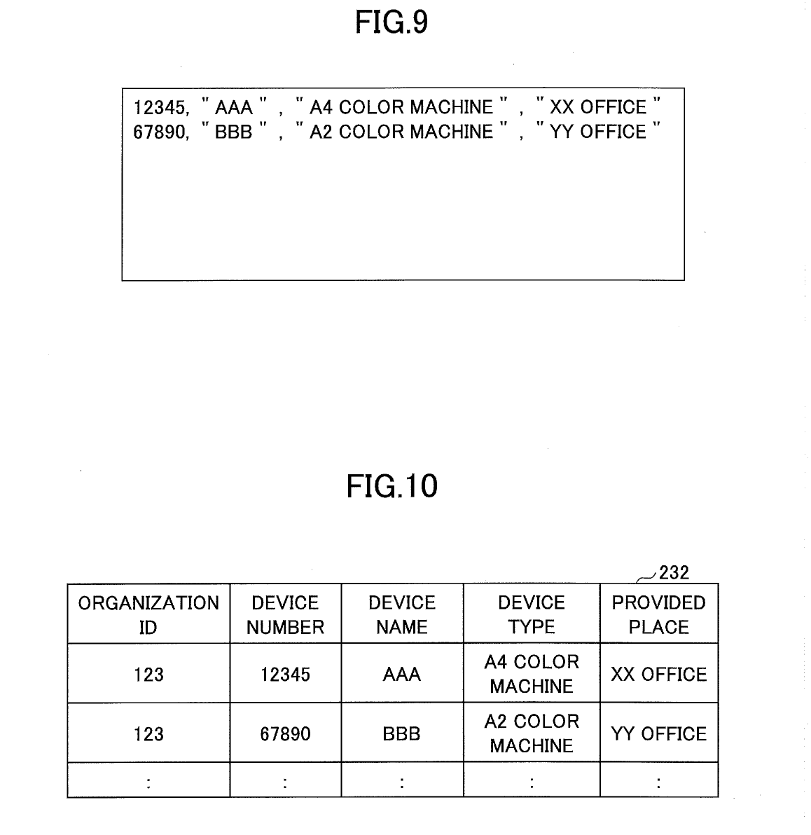

The device information for each of the devices 10 includes items such as “device number”, “device name”, “device type”, “provided place” and the like, for example. Values of these items are described in the device information file in a format as illustrated in FIG. 9, for example.

FIG. 9 is a view illustrating a description example of the device information in the device information file. FIG. 9 illustrates an example in which the device information is described by a Comma Separated Values (CSV) format where values of items are divided by commas. However, the description format of the device information of the device information file is not limited to the CSV format. The description format may be an eXtensible Markup Language (XML) format or other formats.

The “device number” is identification information of the device (individual) of each of the devices 10. For example, a production number or a serial number may be used as the device number. The “device name” is almost the same meaning as a model name. The “device type” is information directly indicating a function of the model of the model name. The “provided place” is place where the device 10 is provided at the user environment E1.

When the file name of the device information file is input in the text box 534t and the registration button 534b is pressed, the administrator terminal 30 sends the device registration request including the device information described in the device information file to the service providing apparatus 20 (S105).

Upon receiving the device registration request, the setting registration unit 221 of the service providing apparatus 20 registers the device information included in the device registration request in the device information storing unit 232 in correspondence with the organization ID of the log-in administrator (S106).

FIG. 10 is a view illustrating an example of a structure of the device information storing unit 232. In FIG. 10, the device information storing unit 232 stores a record for each of the devices 10. Each record includes items such as “organization ID”, “device number”, “device name”, “device type”, “provided place” and the like. The device information storing unit 232 stores association of each of the devices 10 and the organization.

Subsequently, the administrator presses the market place button 532 of the administrator portal screen 530 (FIG. 7) to purchase the scan device application 125, that is the device application necessary to be installed in the device 10 in order to use the Scan To Storage service. In response to pressing of the market place button 532, the administrator terminal 30 displays a market place screen 540.

As illustrated in FIG. 7, the market place screen 540 includes a button for each of the device applications stored in the device application storing unit 233. In FIG. 7, an example is illustrated in which buttons 541 to 543 corresponding to three device applications are included. Among these, the button 541 corresponds to the scan device application 125.

Here, as the scan device application 125 is to be purchased, the button 541 is pressed by the administrator. In response to the pressing of the button 541, the administrator terminal 30 sends the request of purchasing application including the application ID of the scan device application 125 to the service providing apparatus 20 (S107).

Upon receiving the request of purchasing application, the setting registration unit 221 of the service providing apparatus 20 stores the application ID included in the request at the item of the purchased application of the organization record corresponding to the organization ID of the log-in administrator in the user information storing unit 231 (S108). For example, in FIG. 8, the “scan device application” at the item of the “purchased application” of the organization record corresponding to the organization ID=123 is registered at this timing.

Subsequently, the device communication unit 222 obtains the scan device application 125 corresponding to the application ID included in the request of purchasing application from the device application storing unit 233, and delivers it to the devices 10 that belong to the organization ID of the log-in administrator that sent the request of purchasing application (S109). The devices 10 that belong to the organization ID means the devices 10 in correspondence with the organization ID in the device information storing unit 232.

Here, normally, a firewall is provided at the user environment E1. Thus, it is impossible to send the scan device application 125 from the service providing apparatus 20 to each of the devices 10 in the user environment E1. Thus, for example, the scan device application 125 may be returned in a reply to polling from the communication unit 123 of the device 10.

An IP address of the service providing apparatus 20 or a port number to the device communication unit 222 or the like is set in each of the devices 10 in order to cooperate with the service providing apparatus 20. The communication unit 123 of each of the devices 10, for example, periodically performs polling to inquire whether something happens to the IP address and the port number. The inquiry includes, for example, the device number. When the device number designated in the inquiry corresponds to the organization ID of the one that purchases the scan device application 125, the device communication unit 222 of the service providing apparatus 20 returns the scan device application 125.

When a firewall does not exist between the user environment E1 and the service providing apparatus 20, the device communication unit 222 may send the scan device application 125 to the devices 10. In this case, the device information stored in the device information storing unit 232 may include an IP address, a port number or the like of each of the devices 10.

Each of the devices 10 that receives the scan device application 125 installs the scan device application 125 in the device 10 (S110).

Subsequently, when a return button in the market place screen 540 is pressed by the administrator at the administrator terminal 30, the market place screen 540 is not displayed and the administrator portal screen 530 is displayed on the administrator terminal 30.

Here, instead of steps S103 to S110, the following operations and processes may be performed.

For example, the scan device application 125 may be purchased and installed in each of the devices 10 asynchronously with the process steps in FIG. 6. The scan device application 125 may be purchased using a predetermined Web site or the like.

When the scan device application 125 is activated when the device 10 in which the scan device application 125 is installed is activated, the scan device application 125 automatically sends a registration request (hereinafter, referred to as an “auto registration request”) in which the organization ID, the user name and the password of the administrator, the device information of the device 10 and the application ID of the scan device application 125 and the like are designated to the service providing apparatus 20. The organization ID, the user name and the password of the administrator may be input through the administrator terminal 30, for example, and set in the device 10 via the network. Upon receiving the auto registration request, the setting registration unit 221 of the service providing apparatus 20 authenticates the organization ID and the user name and the password of the administrator designated in the auto registration request. The authentication process may be the same as the process explained above regarding step S103. When the authentication succeeds, the setting registration unit 221 registers the organization ID and the device information designated in the auto registration request in the device information storing unit 232. Further, the setting registration unit 221 registers the application ID designated in the auto registration request at the item of the “purchased application” of the user information storing unit 231 in correspondence with the organization ID designated in the auto registration request. By these steps, the organization ID and the device information, and the organization ID and the application ID can be in correspondence with each other.

Further, the auto registration request may include the organization registration request in step S101. This means that the organization record, the management record or the like may be stored in the user information storing unit 231 in response to the auto registration request.

Subsequently, the administrator presses the cooperation button 531 of the administrator portal screen 530 in order to register the account information of the online storage system 40 that cooperates with the Scan To Storage service. In response to pressing of the button 531, a storage cooperation screen 610 is displayed on the administrator terminal 30.

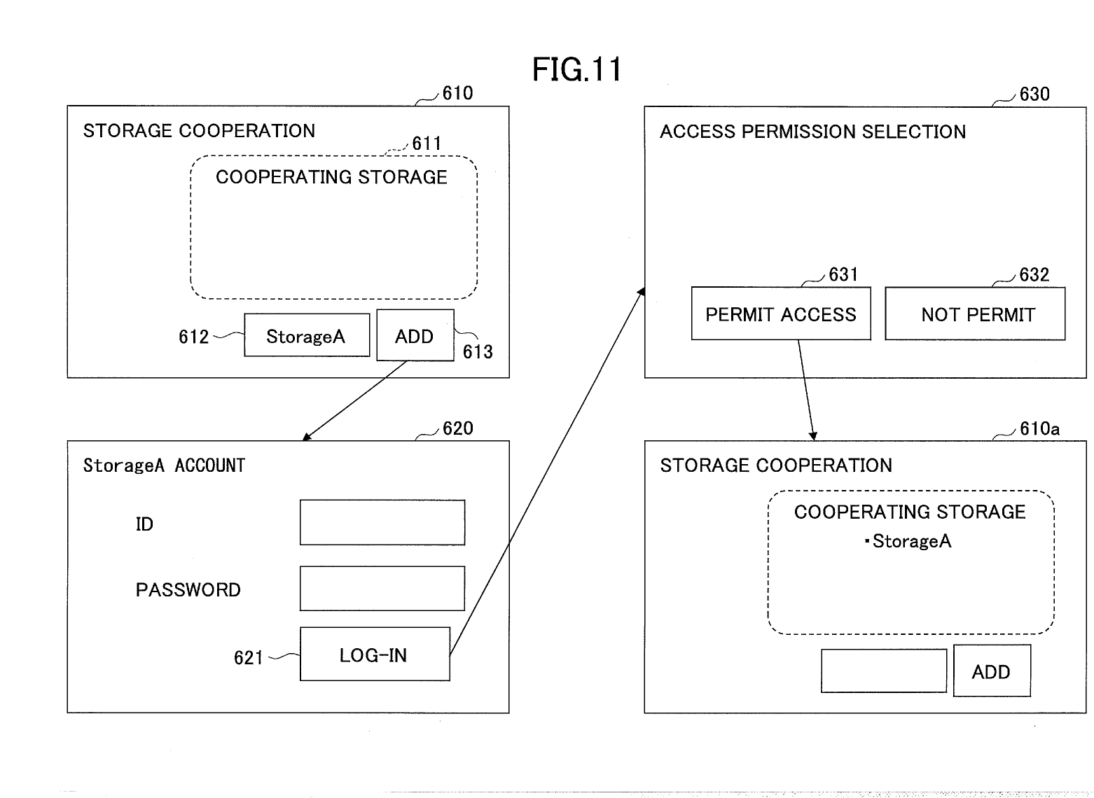

FIG. 11 is a view illustrating a transition example of screens for registering account information of the online storage system to cooperate with.

In FIG. 11, the storage cooperation screen 610 includes a cooperating storage display area 611, a cooperating storage input area 612, an add button 613 and the like. In the cooperating storage display area 611, a name (hereinafter, referred to as a “storage name”) of the online storage system 40 that is selected as a cooperating storage is displayed. When there is the online storage system 40 that is selected as the cooperating storage, the storage name of the online storage system 40 is displayed. The cooperating storage input area 612 is provided for inputting a storage name of the online storage system 40 to be the cooperating storage (hereinafter, referred to as a “cooperating storage”).

When the administrator inputs the storage name (“StorageA”) in the cooperating storage input area 612 and presses the add button 613, the administrator terminal 30 displays an account input screen 620. The administrator terminal 30 accepts an input of account information (ID (mail address or the like, for example) and a password) of the cooperating storage via the account input screen 620 from the administrator. The account information may be previously generated by a user registration or the like to the cooperating storage. When the ID and the password are input and the log-in button 621 is pressed in the account input screen 620, the administrator terminal 30 logs-in the cooperating storage (“StorageA”) based on the ID and the password. Here, the Uniform Resource Locator (URL) of the device to send the log-in request for the cooperating storage may be previously stored in the administrator terminal 30 in correspondence with the storage name, or the URL may be input in the cooperating storage input area 612.

When the log-in succeeds, the administrator terminal 30 displays an access permission selection screen 630. The access permission selection screen 630 is a screen to select whether to permit the access to the cooperating storage by the service providing apparatus 20. When a button 632 (“not permit”) is pressed, the administrator terminal 30 transits to display the administrator portal screen 530. When a button 631 (“permit access”) is pressed, the administrator terminal 30 sends an account registration request of the cooperating storage to the service providing apparatus 20 (S111). The account registration request includes the storage name input in the storage cooperation screen 610 and the account information (the ID and the password) input in the account input screen 620.

In response to the account registration request, the setting registration unit 221 of the service providing apparatus 20 registers the storage name, the ID and the password included in the account registration request at the “storage account information” of the organization record corresponding to the organization ID of the log-in administrator in the user information storing unit 231 (FIG. 8) (S112). Referring to FIG. 8, an example is illustrated in which the storage name of the StorageA and the ID and the password for the StorageA are registered for the organization record of the organization ID=123.

The cooperating storage and the account information for the cooperating storage may be set for each of the users. At this time, one or more area in which capable of inputting a user name may be provided in the storage cooperation screen 610 or the account input screen 620. The user name input in the area is included in the account registration request and is sent to the service providing apparatus 20. The setting registration unit 221 of the service providing apparatus 20 registers the storage name, the ID and the password included in the account registration request in the storage account information of the member record corresponding to the user name included in the request.

When a registration process at the service providing apparatus 20 in accordance with the account registration request succeeds, the administrator terminal 30 displays a storage cooperation screen 610a. The storage name of the cooperating storage is displayed in the cooperating storage display area 611 of the storage cooperation screen 610a. Then, a registration of account information regarding another online storage may be subsequently performed. This means that account information of a plurality of online storages may be registered for one organization record or one member record.

Subsequently, the administrator registers the member users who are permitted to use the Scan To Storage service in the user environment E1.

Specifically, the administrator inputs a file name of a file (hereinafter, referred to as a “user information file”) in which information regarding the member users (hereinafter, referred to as “user information”) in a text box 535t of the user registration area 535 and presses the registration button 535b in the administrator portal screen 530 (FIG. 7).

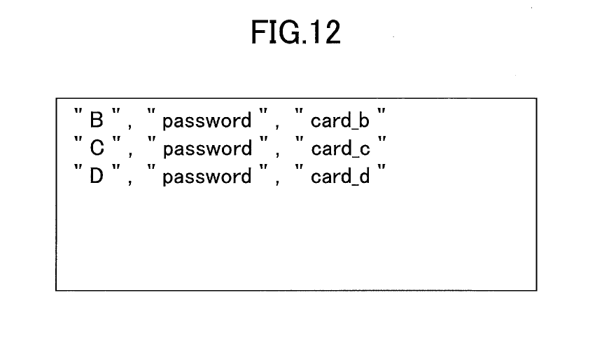

The user information for each of the member users includes items such as “user name”, “password”, “card ID” and the like. These values of the items are described in the user information file in a format as illustrated in FIG. 12.

FIG. 12 is a view illustrating a description example of the user information of the user information file. FIG. 12 illustrates an example in which the user information is described by the CSV format where values of the items are divided by commas. However, the description format of the user information of the user information file is not limited to the CSV format. The description format may be an eXtensible Markup Language (XML) format or other formats.

When the file name of the user information file is input in the text box 535t and the registration button 535b is pressed, the administrator terminal 30 sends the user registration request including the user information described in the user information file to the service providing apparatus 20 (S113).

The setting registration unit 221 of the service providing apparatus 20 registers the user information included in the user registration request in the user information storing unit 231 in correspondence with the organization ID of the log-in administrator (S114). This means that a new user record is generated for each of the user information, and single user information is registered for each of the user records. For the example of FIG. 8, the records whose user name is B, C or D are registered in step S114. The user information regarding the administrator may be included in the user registration request. At this time, the user information regarding the administrator means user information whose name matches the user name of the administrator record. At this time, the content of the administrator record may be updated by the user information included in the user registration request. With this configuration, for example, the card ID of the administrator may be registered at this timing.

Subsequently, the administrator edits or the like a profile that is configuration information of operation screens displayed on the operation panel 15 of each of the devices 10 when using the Scan To Storage service. The profile of the embodiment is information regarding the operation screens of the scan device application 125 and includes layout information of a button on the screen, and information of a reading condition of scan, processing steps on the scanned image data and storage or the like to store (send) the data for each of the buttons.

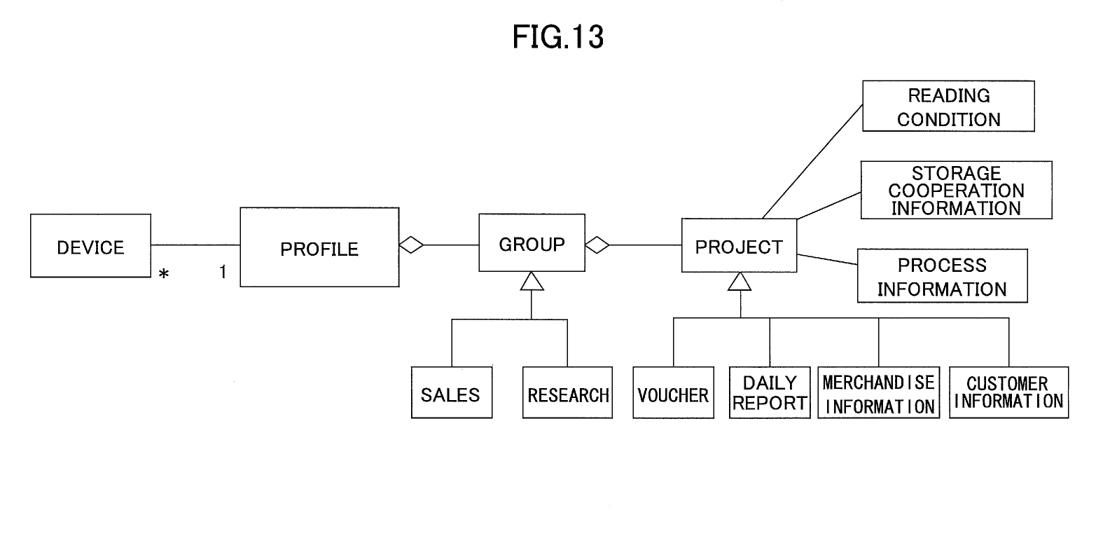

FIG. 13 is a view for explaining a conceptual model of the profile. As illustrated in FIG. 13, each of the devices 10 includes a single profile. Here, different profiles may be set for the different devices 10, respectively, or different profiles for the different users, respectively, may be set for a single device 10.

The profile includes one or more group. The group is a concept corresponding to a tab window in the operation screen, for example. In FIG. 13, “sales” and “research” are illustrated as a specific example of the group. These express a sales tab window and a research tab window.

One group includes one or more project. The project is a concept corresponding to a display component such as a button or the like placed in the tab window, for example. In FIG. 13, “voucher”, “daily report”, “merchandise information”, “customer information” and the like are illustrated as a specific example of the project. These express a label of each of the buttons placed in, for example, a sales tab window.

One project includes a reading condition, storage cooperation information, process information and the like, or is in correspondence with these information. The reading condition is a reading condition when scanning. The storage cooperation information is information indicating a folder of the online storage system 40 in which scanned image data is stored. The process information is information regarding processing (image processing) applied to the scanned image data that is performed before storing.

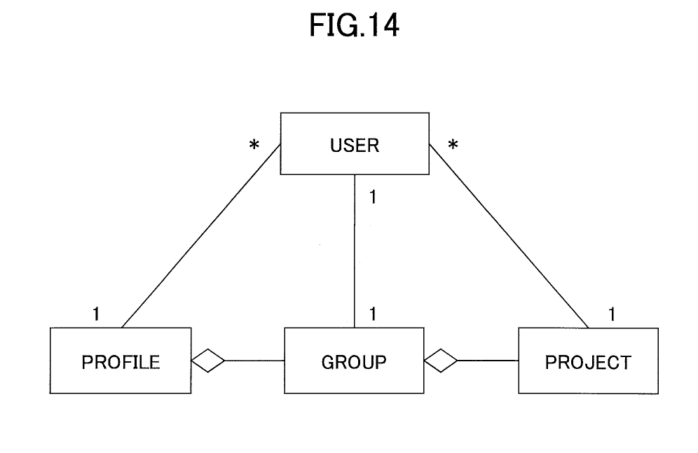

In this embodiment, relationships between the profile, the group and the project and the user are as illustrated in FIG. 14. FIG. 14 is a view for explaining an example of the relationships between the profile, the group and the project and the user.

In FIG. 14, the relationship between the profile and the user is one to many. This means that a plurality of users who use the same device 10 commonly use the same profile associated with the device 10. Thus, the profile is a concept that does not depend on user (user independence).

On the other hand, the relationship between the group and the user is one to one. This means that the definition regarding the group is specific to each user. For example, the button (project) displayed in the tab window corresponding to the group A can be different for the user A and the user B. Further, the fact that the relationship between the group and the user is one to one means that the usable group is different for each of the users. Specifically, while the groups (the tab windows capable of being displayed for the user A) usable for the user A is the group A and the group B, the group usable for the user B may be the group B. Thus, the group is a concept that depends on the user (user dependence).

The relationship between the project and the user is one to many. This means that the definition of one project is common for the plurality of users. Specifically, the screen transition regarding the same button is common for the plurality of the users. Thus, the project is the user independence concept.

As such, the group usable for the same profile can be different for each of the users. Further, the project (the button displayed in the tab window) that belongs to a group can be different for each of the users. However, the processes performable by pressing the same button are the same for the plurality of users.

Here, in this embodiment, each of the profile, the group and the project is actualized by a file in an XML format that is a so-called “screen information file”. The screen information file includes layout information for composing the screen such as a size, position or the like of the display component such as a label, a button or the like. The screen information file may include setting of operations to be performed when initializing each of the components, or when each of the components is operated.

For example, the screen information file of profile includes layout information or the like of the screen in which a tab window is placed corresponding to the group. The screen information file of group includes layout information or the like regarding the tab window. The screen information file of project includes layout information or the like regarding one or more setting screen that is displayed upon selection of the button corresponding to the project. Here, information stored in each of the screen information files is not limited to the above described examples. For example, the layout information regarding each of the tab windows, in other words, the information such as a button or the like corresponding to the project placed in each of the tab windows, may be included in the screen information file of profile. At this time, the screen information file of group may not be generated. Further, at this time, the screen information file of profile may be provided for each user. For example, the screen information file of profile corresponding to the user A may include layout information regarding a group usable by the user A or the like and the screen information file of profile corresponding to the user B may include layout information regarding a group usable by the user B or the like. Thus, at this time, the profile is a user dependence concept and the screen information file of profile is a user dependence screen information file.

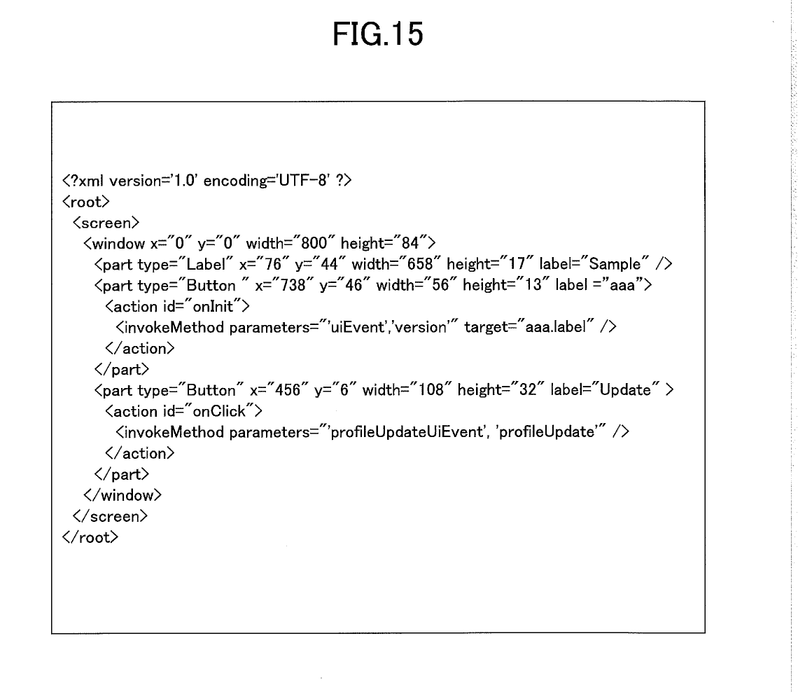

FIG. 15 is a view illustrating a definition example of the screen information file. In FIG. 15, an example of a part of the definition of the screen information file is illustrated, not a specific screen information file, for explanation purposes. In FIG. 15, window components surrounded by <window> tags include a definition regarding a screen. The window component includes an “x” property, a “y” property, a width property and a height property. Values of the “x” property and the “y” property indicate a position of a left-upper corner in a predetermined coordinate system. Values of the width property and the height property indicate width and height of the screen.

The window component includes one or more part component as a child component. One part component includes a definition regarding one display component. The part component includes a type property, a label property or the like in addition to the “x” property, the “y” property, the width property and the height property.

A value of the type property indicates a type of the display component. For example, “Label” indicates a label and “Button” indicates a button. The display component that is operable such as a button or the like includes an action component as the child component. The action component includes information indicating processes to be performed in accordance with the operation to the display component.

The screen information file is provided for each of the profile, the group and the project and for each of the languages (Japanese, English, other languages or the like). For example, the screen information file of group A and the screen information file of group B are different.

Similarly, the screen information file of the project A and the screen information file of the project B are different. However, for example, after selecting the button corresponding to the project A, when transition to a plurality of screens occurs, the definitions regarding the plurality of screens are included in a single screen information file. Further, even the screen information file for the same profile, the group or the project, the screen information file for Japanese (Japanese version) and the screen information file for English (English version) are different files, for example. The screen information file for Japanese means a screen information file by which a character string illustrated on the display component is Japanese. However, the relationship between the profile, the group and the project and the screen information file, or the relationship between the language and the screen information file is not necessarily as described above.

Further, as described above, the profile is the user independence concept in this embodiment. Thus, the screen information file of profile is an example of the user independence screen information file. The group is a user dependence concept. Thus, the screen information file of group is an example of the user dependence screen information file. The project is a user independence concept. Thus, the screen information file of project is an example of the user dependence screen information file.

Referring back to the explanation of the administrator portal screen 530 (FIG. 7), in the administrator portal screen 530, when the profile setting button 533 is pressed, the administrator terminal 30 displays the profile setting screen 550. As illustrated in FIG. 7, the profile setting screen 550 includes a profile editing button 551 and a device setting button 552. When the administrator selects the profile editing button 551, a profile editing screen 710 is displayed on the profile setting screen 550, on the administrator terminal 30.

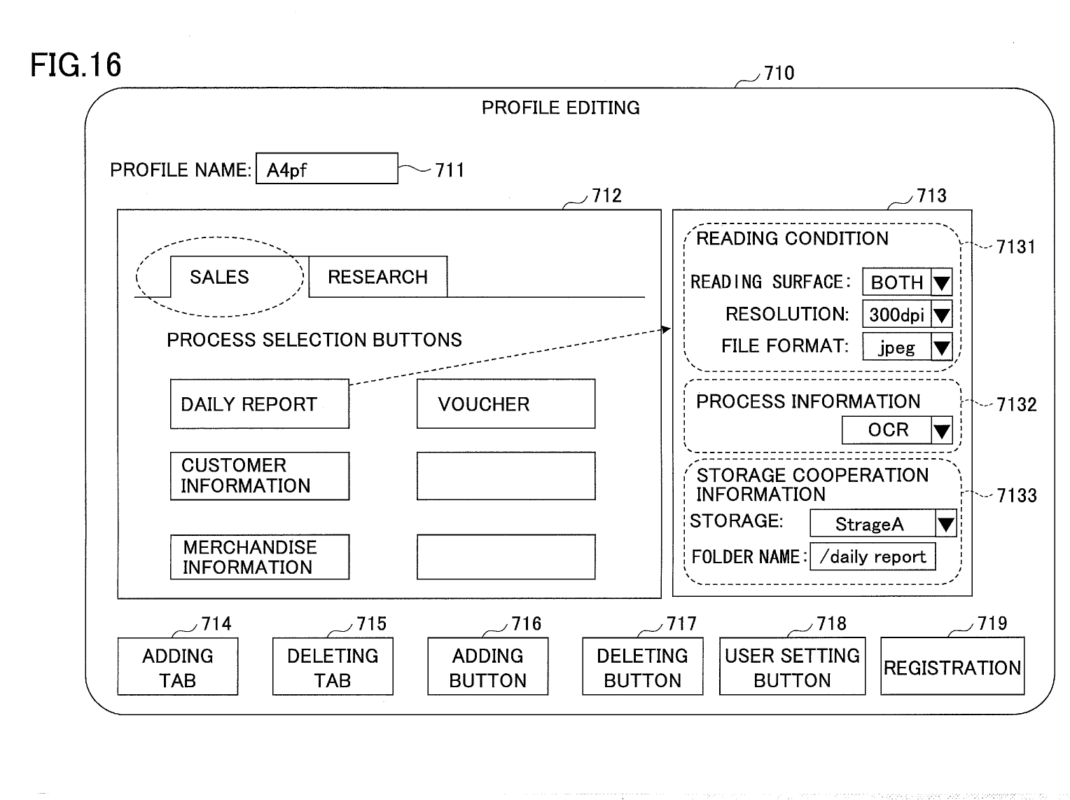

FIG. 16 is a view illustrating a display example of the profile editing screen 710. In FIG. 16, the profile editing screen 710 includes a profile name input area 711, an editing target screen display area 712, a button editing area 713, editing buttons 714 to 717, a user setting button 718, a registration button 719 and the like.

The profile name input area 711 is an area to accept an input of a profile name. The editing target screen display area 712 is an area in which a screen (the operation screen of the scan device application 125) that is an editing target is displayed. In FIG. 16, an example of the screen corresponding to the conceptual model illustrated in FIG. 13 is displayed. This means that an example of a screen is illustrated in which a sales tab window and a research tab window are displayed and a daily report button, a customer information button, a merchandise information button, a voucher button and the like are included in the sales tab window, as editing targets.

The editing buttons 714 to 717 are buttons for adding a new tab window, deleting the editing target tab window, adding a button to the editing target tab window, deleting the selected button in the editing target tab window and the like.

The initial state of the editing target screen display area 712 may be a state in which a button is placed in a tab window, or may be a state based on the profile previously generated as a model.

In the editing target screen display area 712, the selected button (hereinafter, referred to as a “target button”) becomes the editing target of the editing button 717 or the button editing area 713. The button editing area 713 includes, for example, a reading condition setting area 7131, a process information setting area 7132, a storage cooperation information setting area 7133 and the like.

The reading condition setting area 7131 is an area to accept setting of a reading condition regarding scan that is performed when the target button is pressed. Although “reading surface”, “resolution”, and “file format” are illustrated as an example of setting items in FIG. 16, other items such as a color mode or the like may be capable of being set.

The process information setting area 7132 is an area to accept setting of processing steps to image data scanned in response to pressing of the target button. In FIG. 16, an example in which Optical Character Recognition (OCR) is set is illustrated. At this time, a result of the OCR is to be stored. Other than OCR, translation of the OCR result, conversion of the data format of the image data or the like may be set as the processing steps. Further, a combination of a plurality of the processing steps may be capable of being set.

The storage cooperation information setting area 7133 is an area to accept setting of storage to store data that is scanned in response to pressing of the target button and to which the processing steps are performed in accordance with necessity. In FIG. 16, an example in which the storage name of the online storage to which the data is stored, and the folder name of the online storage are capable of being set is illustrated. The storage name selectable to store the data is the storage name registered in the storage account information of the organization record (FIG. 8) corresponding to the organization ID of the log-in administrator. The folder name becomes the button name (label) of the target button. This means that when the folder name is changed, the button name of the target button is changed. However, the button name and the folder name may not be necessarily the same.

The setting in the profile editing screen 710 illustrated in FIG. 16 may be performed for each of the languages. Further, a setting for a specific language (Japanese, for example) may be performed in the profile editing screen 710, and the screen information file for another language may be automatically or manually generated at the service providing apparatus 20 side. Further, the content that is set in the profile editing screen 710 may be a definition of a full specification regarding a profile, for example. The full specification regarding the profile means a definition including all of the groups that belong to the profile and all of the projects that belong to each of the groups.

On the other hand, the setting regarding the user dependence group may be performed via a user setting screen that is displayed in accordance with pressing of the user setting button 718, for example. In the user setting screen, a list of user names stored in the user information storing unit 231 in correspondence with the organization ID of the log-in administrator, a list of identification information (group name) of the group set in the profile editing screen 710, and a list of identification information (project name) of the project that belongs to the group, for each of the groups, are displayed. It is possible to select a group usable for the user of the user name selected from the list of the user names from the list of the group names. Further, it is possible to select a project usable for the user from the list of the project names among the projects that belong to the group of the selected group name. The position of the button corresponding to the selected project name on the tab window may be adjusted in the user setting screen.

When the necessary editing is completed and the registration button 719 is pressed in the profile editing screen 710, the administrator terminal 30 sends the profile registration request including the edited content in the profile editing screen 710 to the service providing apparatus 20 (S115). In response to the profile registration request, the setting registration unit 221 of the service providing apparatus 20 registers information included in the registration request in the profile storing unit 234 in correspondence with the organization ID of the log-in administrator (S116).

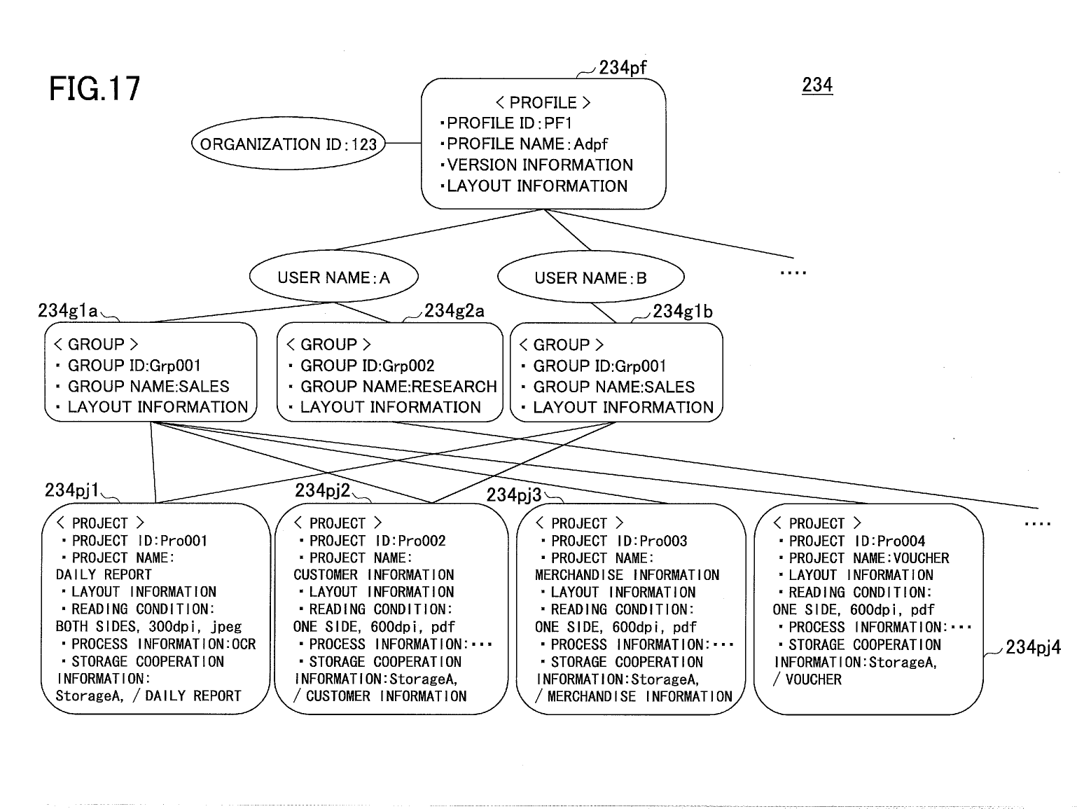

FIG. 17 is a view for explaining information stored in the profile storing unit 234. In FIG. 17, the rectangular box with rounded corners expresses a screen information file. The line connecting the rectangular boxes expresses a relationship (parent-child) between the screen information files. This means that information included in the profile registration request is stored as the screen information file in the profile storing unit 234, in step S116.

In FIG. 17, the screen information file of profile 234pf, the screen information files of group 234g1a, 234g2a and 234g1b, the screen information files of project 234pj1, 234pj2, 234pj3 and 234pf4 and the like are displayed. Here, the screen information files of group 234g1a, 234g2a and 234g1b are referred to as a “screen information file 234g” when they are not differentiated. Further, the screen information files of project 234pj1, 234pj2, 234pj3 and 234pf4 are referred to as a “screen information file 234pj” when they are not differentiated.

The screen information file 234pf includes “profile ID”, “profile name”, “version information”, “layout information” and the like. The “profile ID” is identification information of the profile. The profile ID may be automatically allocated by the setting registration unit 221, or may be capable of setting in the profile editing screen 710. The “profile name” is a name of the profile given by the user (administrator). The “version information” is information (numerical value, for example) indicating version (version number) of the profile. For the value of the version information, for example, “1” may be given for the first registration, and thereafter, “1” may be added every time change is made for the profile itself, or the group or the project that belongs to the profile. The “layout information” is, for example, layout information of the screen in which the tab window corresponding to the group is placed. The screen information file 234pf is stored in correspondence with the organization ID of the log-in administrator. The screen information file 234g and the screen information file 234pf may be directly associated with the organization ID.

The screen information files of group 234g are classified by ellipse boxes in each of which the user name is described. This means that the screen information files 234g are generated for each of the user names as the screen information files 234g are the user dependence screen information, and are stored in correspondence with the user names, respectively. For example, in FIG. 17, an example is illustrated in which the screen information files 234g1a and 234g2a are generated for the user A and the screen information file 234g1b is generated for the user B. Here, although the screen information file 234g1a for the user A and the screen information file 234g1b for the user B is the screen information file 234g for the same group whose group ID is “Grp001”, as the screen information files of group 234g is the user dependence screen information file, these are generated for each of the users.

Each of the screen information files of group 234g includes “group ID”, “group name”, “layout information” and the like. The “group ID” is identification information for each of the groups, and may be automatically allocated similarly to the profile ID. The “group name” is an identification name of the group given by the user, and is used as a label displayed at a tab of the tab window corresponding to the group. The “layout information” is position information of each of the buttons in the tab window corresponding to the group. For example, the screen information file 234g1a has relationship with four of the screen information files 234pj corresponding to four projects, respectively. Thus, the layout information of the screen information file 234g1a includes layout information regarding the four buttons. Meanwhile, the screen information file 234g1b relates to two of the screen information files 234pj corresponding to two projects, respectively. Thus, the layout information of the screen information file 234g1b includes layout information regarding two buttons.

Each of the screen information files of project 234pj includes “project ID”, “project name”, “layout information”, “reading condition”, “process information”, “storage cooperation information” and the like. The “project ID” is identification information for each of the projects, and may be automatically allocated similarly to the profile ID. The “project name” is an identification name of the project given by the user, and is used as a label of a button corresponding to the project. In this embodiment, the project name matches the folder name of the storage cooperation information. The “layout information” is layout information of one or more setting screen that is displayed when the button corresponding to the project is pressed. The “reading condition”, the “process information” and the “storage cooperation information” are the same as described above regarding the profile editing screen 710 (FIG. 16).

The screen information files of project 234pj are the user independence screen information files. Thus, each of the screen information files of project 234pj may relate to a plurality of the screen information files of group 234g that are generated for each of the users. In FIG. 17, for example, the screen information file 234pj1 relates to the screen information file 234g1a and the screen information file 234g1b.

Although the screen information files for one language are illustrated in FIG. 17, the screen information file group as illustrated in FIG. 17 is generated for each of the languages. Further, as illustrated in FIG. 17, the screen information file includes information other than the layout information. The example of the screen information file illustrated in FIG. 15 is illustrated by mainly extracting the layout information among information included in the screen information file.

Further, the relationship between the screen information files (the line in FIG. 17) may be stored in a file (hereinafter, referred to as a “relation file”) that stores information indicating the relationship. For example, for the user A, four relation files including relation files storing correspondences between the profile ID and group IDs of the two groups, respectively, and relation files for the two groups each storing a correspondence between the group ID and the project IDs related to the respective group may be generated. Further, for the user B, a relation file storing a correspondence between the profile ID and the group ID of the group and a relation file storing a correspondence between the group ID of the group and the project IDs of the two projects related to the group may be generated. In this embodiment, for explanation purposes, it is assumed that the screen information file of group 234g includes link data to the screen information file of profile 234pf and link data to the screen information files of the project 234pf. For example, the screen information file 234g1b for the user B includes link data to the screen information file 234pf and link data to the screen information files 234pj1 and 234pj2. The link data may be, for example, the profile ID, the project ID, or a file name of the screen information file to be referred.

Here, when the screen information file of group 234g is not generated and the screen information files of profile 234pf are generated for the users, respectively, each of the screen information files 234pf may include the information that are explained to be included in the screen information file of group 234g in FIG. 17.

Subsequently, when the device setting button 551 of the profile setting screen 550 (FIG. 7) is pressed by the administrator, the administrator terminal 30 displays a profile device setting screen 720.

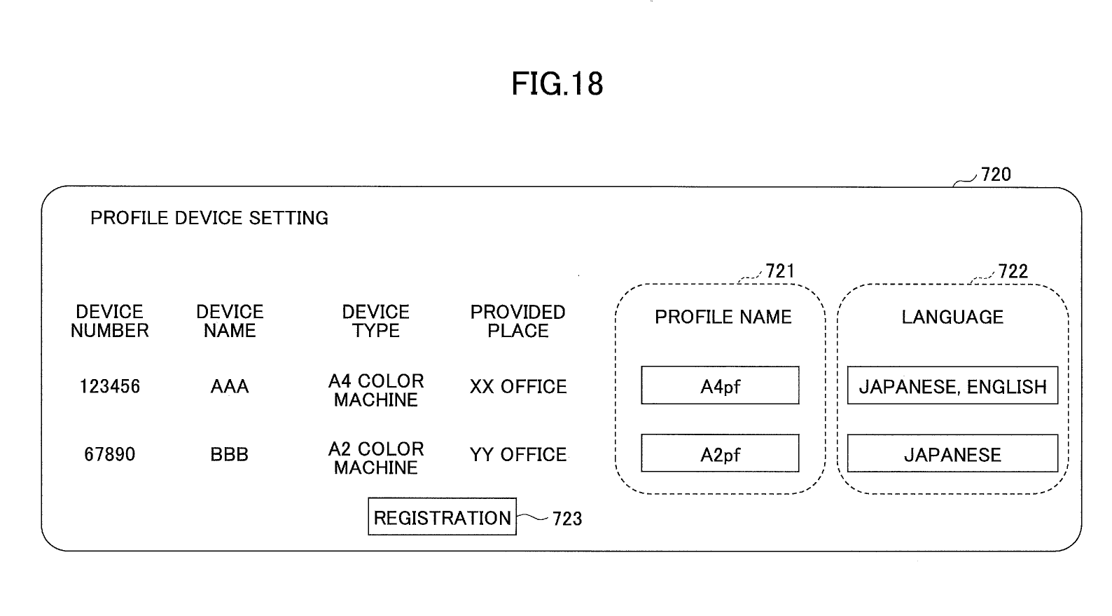

FIG. 18 is a view illustrating a display example of the profile device setting screen 720. The profile device setting screen 720 is a screen for setting the correspondence between the profile and the language with each of the devices 10. As illustrated in FIG. 18, in the profile device setting screen 720, a profile name input area 721 and a language selection area 722 are displayed for each of the devices 10 whose device information are stored in the device information storing unit 232 in correspondence with the organization ID of the log-in administrator. The administrator inputs a profile name of the profile to correspond with (used in) each of the devices 10 in the profile name input area 721. The administrator further selects an identification name (hereinafter, referred to as a “language name”) of the language used in the screen displayed at each of the devices 10 in the language selection area 722. For example, one or more language name may be directly input, or a dialog or the like in which a plurality of language names are raised as selections may be displayed and one or more language name may be selected via the dialog or the like. The administrator may select the language name to correspond with each of the devices 10 based on the place or region where each of the devices 10 is placed, the language or the like used by the user at the place where the device 10 is placed, for example. After inputting the profile name and selecting the language name, the administrator presses the registration button 723.

In response to pressing of the registration button 723, the administrator terminal 30 sends the registration request including the setting content (a combination of the device number, the profile name and the language name, for example) in the profile device setting screen 720 to the service providing apparatus 20. The setting registration unit 221 of the service providing apparatus 20 registers the information included in the registration request in the profile device correspondence storing unit 235.

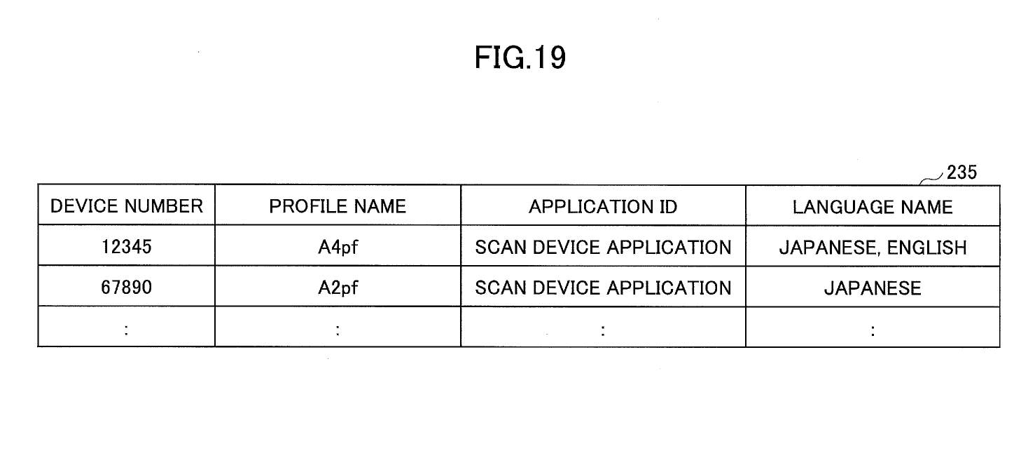

FIG. 19 is a view illustrating an example of a structure of the profile device correspondence storing unit 235. The profile device correspondence storing unit 235 stores the device number, the profile name, the application ID of the device application and the language name in correspondence with each other. The application ID to be associated with is the application ID of the device application selected in the market place screen 540 (FIG. 7). This means that the setting registration unit 221 stores the application ID of the device application in the memory device 203 or the like in correspondence with the log-in administrator and stores the application ID in the profile device correspondence storing unit 235 in correspondence with the setting content, upon the registration request of the setting content in the profile device setting screen 720.

Subsequently, when a log-out button 536 of the administrator portal screen 530 (FIG. 7) is pressed (S117), the administrator terminal 30 sends a log-out request to the service providing apparatus 20. Upon receiving the log-out request, the service providing apparatus 20 releases the log-in status of the log-in administrator.

The preparatory work by the administrator for using the Scan To Storage service is completed. Subsequently, process steps that are performed by the data processing system 1 when the Scan To Storage service is used by the member user are explained.

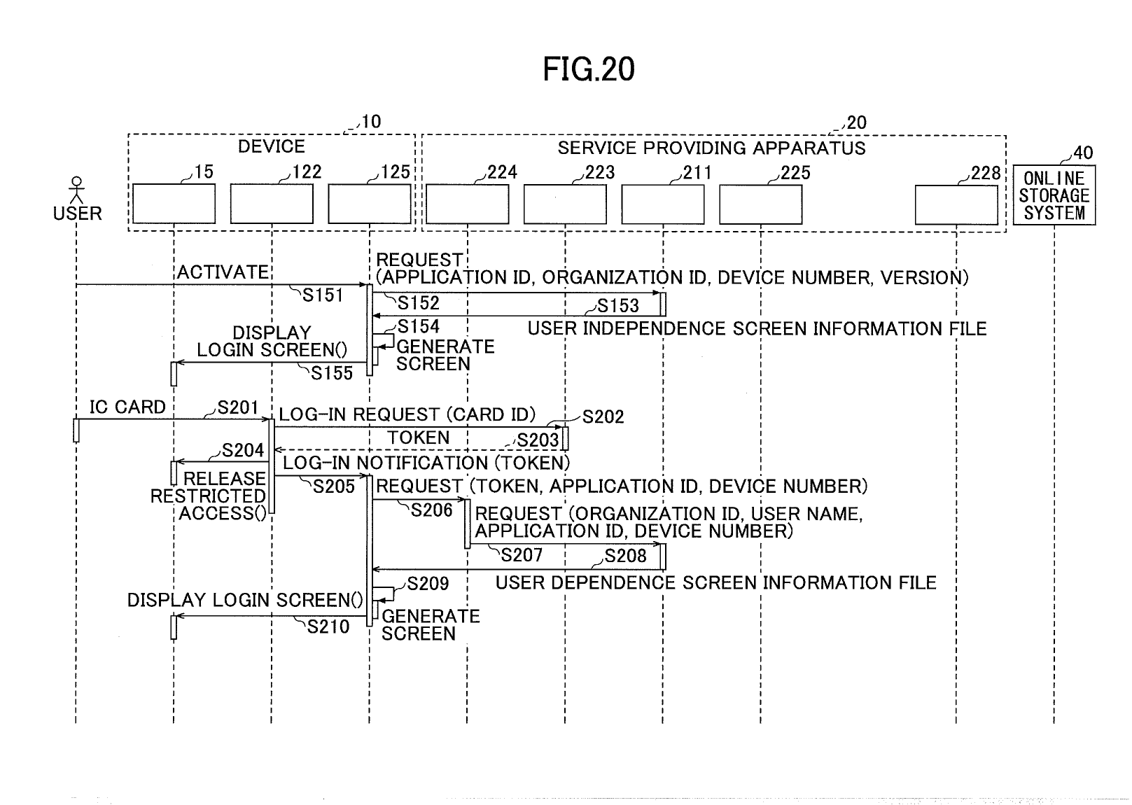

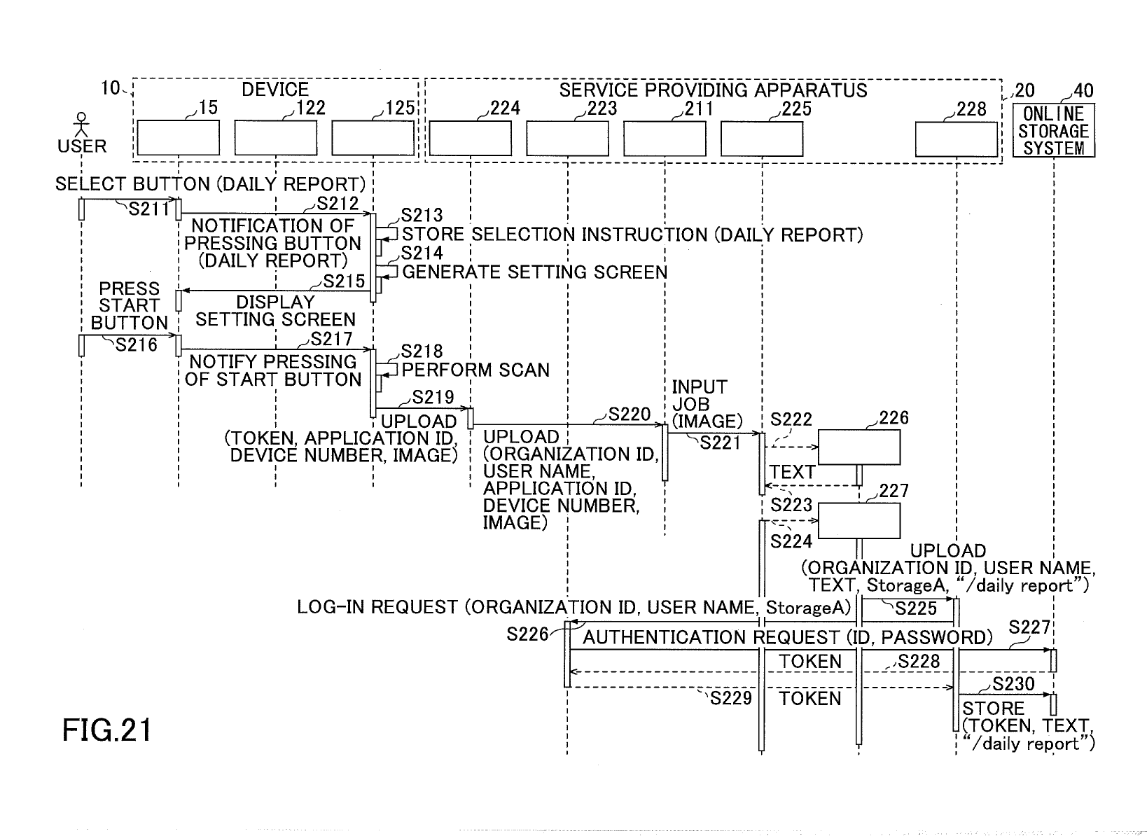

FIG. 20 and FIG. 21 are sequence diagrams illustrating an example of process steps when using the Scan To Storage service. In the explanation of FIG. 20 and FIG. 21, the device 10 to be operated is simply referred to as the “device 10” and the member user who operates the device 10 is simply referred to as the “user”. Further, it is assumed that any of the users log-in the device 10 at the time of starting the processes illustrated in FIG. 20.

For example, when the scan device application 125 is activated in accordance with an operation by the user via the operation panel 15 (S151), the scan device application 125 designates its own application ID, the organization ID, the device number of the device 10 (own) and the like, and sends an obtaining request of the screen information file to the scan server application 211 of the service providing apparatus 20 (S152). The organization ID is previously stored in the device 10. Here, when the screen information file is obtained (downloaded) before, the version information of the screen information file is also designated in the obtaining request. The version information is included in, for example, the screen information file of profile. Further, step S151 may be performed in accordance with the activation of the device 10. This means that step S151 may be performed by an automatic activation of the scan device application 125 in accordance with the activation of the device 10.

The scan server application 211 specifies the profile name and the language name in correspondence with the application ID and the device number designated in the obtaining request, by referring to the profile device correspondence storing unit 235 (FIG. 19). The scan server application 211 obtains the screen information file corresponding to the language name and that is the user independence screen information file from the profile storing unit 234 (FIG. 17) among the screen information file groups regarding the profile name. Then, the scan server application 211 returns the obtained screen information file to the scan device application 125 (S153). In this embodiment, the user independence screen information file is the screen information file of profile 234pf and the screen information file of project 234pj. Thus, in step S153, the screen information file 234pf and the screen information file 234pj are returned. On the other hand, the screen information file of group 234g is the user dependence screen information file. Thus, the screen information file 234g is not returned in step S153. Here, when the layout information of the tab window corresponding to the group is included in the screen information file of profile 234pf, the screen information file 234pf becomes the user dependence screen information file. At this time, the screen information file of profile 234pf is not returned in step S153.

When the version information is designated in the obtaining request of the screen information file, if the version information included in the screen information file of profile 234pf obtained from the profile storing unit 234 matches the version information designated in the obtaining request, the screen information file may not be returned. In other words, the screen information file may be returned when the compared version information are different. This is because if the compared version information match, that means that the device 10 has already include the screen information file to be returned.

The scan device application 125 stores the returned screen information file group in the HDD 114, for example. Then, the version information included in the screen information file of profile stored in the HDD 114 is designated in the request in the following steps S152.

Subsequently, the scan device application 125 generates the operation screen based on the screen information file of profile 234pf among the screen information file group stored in the HDD 114 (S154). Here, as the screen information file of group 234g is not obtained yet, an operation screen substantially impossible to operate is generated. Subsequently, the scan device application 125 displays the log-in screen for authenticating the scan device application 125 to overlap on the operation screen (S155). When the screen information file of profile 234pf is the user dependence screen information file and is not returned in step S153, a predetermined operation screen may be generated or only a log-in screen may be displayed, without generating the operation screen, in step S154.

When the user carries an IC card to a card reader (not illustrated in the drawings) of the device 10 in order to log-in the device 10 in response to displaying the log-in screen, the device authentication unit 122 obtains the card ID of the IC card via the card reader (S201). Subsequently, the device authentication unit 122 sends the authentication request that includes the card ID to the service providing apparatus 20 (S202). Here, for the log-in by the user, another measure other than the IC card may be used. For example, the user name and the password may be input.

Upon receiving the authentication request, the authentication processing unit 223 of the service providing apparatus 20 authenticates the card ID included in the authentication request. For example, when the record that includes the card ID is stored in the user information storing unit 231, the authentication may be treated to be a success. Further, the organization ID and the device number may be sent with the card ID from the device 10. At this time, when there is no contradiction to the combination of the organization ID, the device number and the card ID, the authentication may be treated to be a success. When the authentication succeeds, the session management unit 224 starts the session with the device 10. The session management unit 224 stores the organization ID and the user name that are in correspondence with the card ID in the user information storing unit 231, in the memory device 203 in correspondence with the session. The session management unit 224 generates a token (cookie) that is the identification information of the session. The authentication processing unit 223 returns the token to be included in the response indicating that the authentication is succeeded to the device authentication unit 122 of the device 10 (S203).

Upon receiving the response indicating that the authentication is succeeded, the device authentication unit 122 stores the token included in the response in the RAM 112. The device authentication unit 122 releases the restricted access (lock) to the operation panel 15 so that the user can operate the operation panel 15 (S204). When the restricted access is released, the log-in screen disappears.

Subsequently, the device authentication unit 122 notifies that the log-in is succeeded to each of the application activated in the device 10. In this embodiment, the scan device application 125 is also notified of the log-in success (S205). The notification of the log-in success includes the token. Thus, the scan device application 125 can receive the token via the notification.

Subsequently, the scan device application 125 designates its own application ID, the token, the device number of its own device 10 and the like, and sends the obtaining request of the screen information file to the scan server application 211 of the service providing apparatus 20 (S206). The session management unit 224 of the service providing apparatus 20 relays the obtaining request. When relaying, the session management unit 224 converts the token included in the obtaining request to the organization ID and the user name of the session identified by the token, and transfers the obtaining request to the scan server application 211 (S207). Here, the session management unit 224 rejects a request including unauthorized token.

Subsequently, the scan server application 211 specifies the profile name and the language name that are in correspondence with the application ID and the device number designated in the obtaining request by referring to the profile device correspondence storing unit 235 (FIG. 19). The scan server application 211 obtains a screen information file corresponding to the language name and that is in correspondence with the user name designated in the obtaining request from the profile storing unit 234 (FIG. 17) among the screen information files regarding the profile name, and returns the obtained screen information file to the scan device application 125 (S208). In this embodiment, the user dependence screen information file is the screen information file of group 234g. Thus, in step S208, the screen information file 234g that belongs to the profile of the profile name designated in the obtaining request of the screen information file and is in correspondence with the user name designated in the obtaining request is returned. Here, when the screen information file of profile 234pf is the user dependence screen information file, in step S208, the screen information file of profile 234pf is also returned. Further, when the screen information file of profile 234pf is the user dependence screen information file, and the screen information file of group 234g is not generated, in step S208, the screen information file of group 234g is not returned. At this time, in the following steps, the processes that are explained as being performed by using the screen information file of group 234g may be performed by using the screen information file of profile 234pf.

The scan device application 125 stores the returned screen information file in the HDD 114, for example. Subsequently, the scan device application 125 generates an operation screen based on the screen information file group stored in the HDD 114 (S209). Here, the screen information file of group 234g corresponding to the log-in user is also stored. Thus, the operation screen including a tab window is generated based on the screen information file 234g.

Subsequently, the scan device application 125 controls the operation panel 15 to display the operation screen (S210).

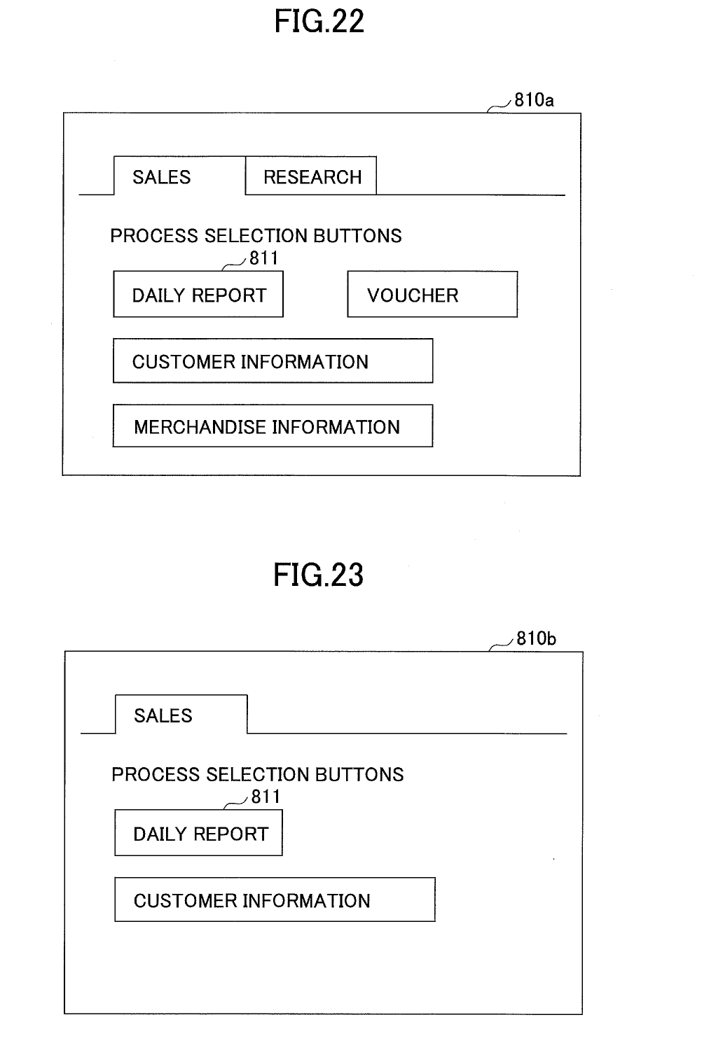

FIG. 22 is a view illustrating a first display example of an operation screen of the scan device application. The operation screen 810a illustrated in FIG. 22 is a display example of an operation screen corresponding to the user A. In FIG. 17, the user A is in correspondence with two groups whose group names are “sales” and “research”. The “sales” group of the user A is associated with four projects, whose project names are “daily report”, “customer information”, “merchandise information” and “voucher”. Thus, two tab windows corresponding to the two groups are displayed in the operation screen 810a and four buttons are displayed in the tab window of the “sales” group.

When the user B is the log-in user, the operation screen as illustrated in FIG. 23 is displayed. FIG. 23 is a view illustrating a second display example of the operation screen of the scan device application.

Based on FIG. 17, the user B is not in correspondence with the “research” group. Thus, a tab window of the “sales” group is displayed in the operation screen 810b. The “sales” group in correspondence with the user B is not in correspondence with the “merchandise information” project and the “voucher” project. Thus, buttons of the “daily report” project and the “customer information” project are displayed in the tab window.

Hereinafter, the operation screen 810a and the operation screen 810b are referred to as “operation screen 810” when they are not differentiated.

Subsequently, the user selects a button that is adaptable for the work of the user among the buttons in the operation screen 810 (S211 in FIG. 21). For example, when a daily report is a scan target, the button 811 is selected. When the selection of the button is notified by the operation panel 15 (S212), the scan device application 125 stores the group name and the project name corresponding to the selected button 811 (“daily report”) in the RAM 112 (S213).

The scan device application 125 further generates a setting screen for setting the setting data to the project based on the screen information file of project 234pj of the project name (S214), and displays the setting screen in the operation panel 15 (S215). The content that is set in the setting screen is the reading condition of the scan, for example. At the initial state of the setting screen, the reading condition included in the screen information file of project may be selected. Further, when a screen transition occurs for the setting screen, processes of steps S214 and S215 may be repeated every time the screen transition occurs.

When the setting of the reading condition via the setting screen is completed, a document (daily report) to be scanned is set at the device 10, and the start button in the operation panel 15 is pressed (S216), the operation panel 15 notifies the pressing of the start button to the scan device application 125 (S217). In response to the notification of the pressing of the start button, the scan device application 125 controls the device 10 to perform the scan job of the document via the device control unit 121 (S218). Thus, image data is read from the document by the scanner 12. At this time, the reading condition that is set via the setting screen is used.

Subsequently, the scan device application 125 sends (uploads) the image data with its own application ID, the device number, the group name and the project name of the selected button, and the token to the scan server application 211 (S219). The session management unit 224 converts the token to the organization ID and the user name, and transfers the converted result, the application ID, the device number, the group name and the project name and the image data to the scan server application 211 (S220).

The scan server application 211 specifies the profile corresponding to the transferred application ID and the device number based on the profile device correspondence storing unit 235, and specifies the process information and the storage cooperation information by referring to the screen information file of project corresponding to the transferred group name and the project name among the groups and the projects that belong to the profile.

The scan server application 211 inputs a request of performing the job (hereinafter, referred to as a “job A”) that indicates the process in accordance with the process information and the storage cooperation information to the job processing unit 225 (S221). Here, it is assumed that the process information indicates to perform the OCR process, and the storage cooperation information indicates to store (upload) to the “/daily report” folder of the StorageA. Further, the job is in correspondence with the organization ID of the device 10, the user name and the scanned image data. The request of performing the job is accumulated in a job queue formed at the RAM 112. The job is asynchronously performed from the request of performing the job. However, the job may be performed synchronously with the request of performing the job.

Subsequently, the job processing unit 225 takes out the job A from the job queue, and requests to perform the OCR process to the OCR processing unit 226 based on the process information of the job A (S222). The OCR processing unit 226 performs the OCR process on the image data and outputs a text data as the processed result (S223).

Subsequently, the job processing unit 225 designates the text data, the storage name and the folder name indicated by the storage cooperation information, the organization ID and the user name, and requests the upload processing unit 227 to upload the data (S224). The upload processing unit 227 requests the storage cooperation unit 228 to upload the data (S225).

The storage cooperation unit 228 requests to log-in to the online storage system 40 of the designated storage name to the authentication processing unit 223 (S226). The storage cooperation unit 228 designates the organization ID and the storage name designated in the upload request in the log-in request. The authentication processing unit 223 obtains the organization record corresponding to the organization ID from the user information storing unit 231 and obtains the account information (the ID and the password) that is in correspondence with the storage name of the upload request in the storage account information of the organization record. The authentication processing unit 223 sends the authentication request to the online storage system 40 of the StorageA (hereinafter, simply referred to as a “StorageA”) using the obtained account information (S227).

When the authentication is succeeded for the account information designated in the authentication request, the StorageA returns a token for accessing to the StorageA (S228). The authentication processing unit 223 returns the returned token to the storage cooperation unit 228 (S229).

Subsequently, the storage cooperation unit 228 sends a request to store the text data obtained by the OCR process to the online storage (StorageA) specified by the storage name designated in the upload request while designating the token (S230). At this time, the folder name (/daily report) designated in the upload request is designated as the folder to store.

As a result, the text data is stored in the /daily report of the StorageA.

Here, the user dependence screen information files may be deleted by the scan device application 125 when the user logs-out, for example. With this configuration, increase of the amount of consumption of the HDD 114 can be suppressed.

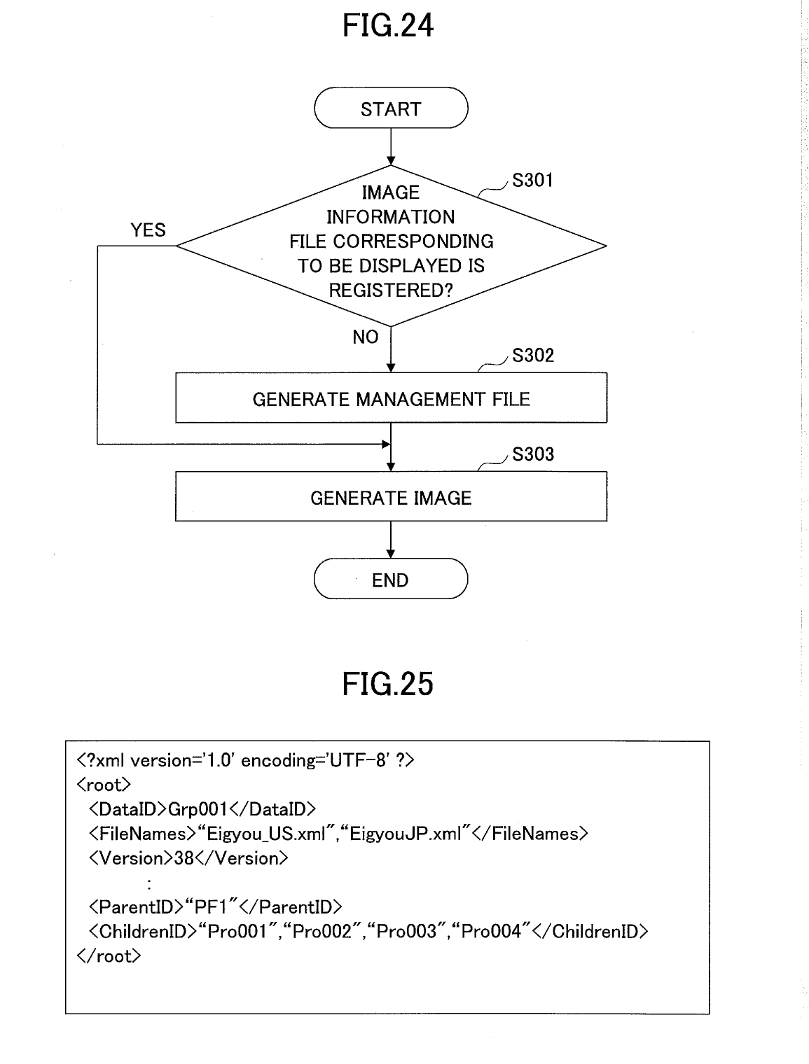

Subsequently, processes of steps S154 and S209 in FIG. 20 and a step S214 in FIG. 21 or the like that are performed when generating screens are explained. FIG. 24 is a flowchart for explaining an example of process steps that are performed when generating screens based on the screen information file.

In step S301, the scan device application 125 determines whether the screen information file corresponding to the profile, the group, or the project to be displayed is registered. The profile, the group, or the project to be displayed is, for example, a screen corresponding to the profile, a tab window corresponding to the group, a setting screen corresponding to the project or the like. Further, the “registration” means that a management file is generated for the screen information file. The management file is a file in which management information of the screen information file is stored. The management file is generated in a predetermined folder, for example. Thus, whether the management file for the screen file to be displayed exists can be determined by referring to the predetermined folder.

When the corresponding management file does not exist (NO in S301), the scan device application 125 generates a management file corresponding to the profile, the group or the project to be displayed (S302). This means that the management file is generated for each of the profile IDs, each of the group IDs and each of the project IDs.

FIG. 25 is a view illustrating an example of the management information stored in the management file. FIG. 25 illustrates an example in which the management information is described by the XML format. However, the description format of the management information may be other formats.

The management information in FIG. 25 includes a DataID component, a FileNames component, a Version component, a ParentID component, a ChildrelID component and the like in a root component.

The value of the DataID component is the profile ID, the group ID or the project ID of the profile, the project or the group corresponding to the management information, respectively. In FIG. 25, the management information corresponding to the “sales” group is illustrated. Thus, the group ID of the group is used as the value of the DataID component.

The value of the FileNames component is the file name of the screen information file of the profile, the group or the project corresponding to the management information. In FIG. 25, two file names are included as the values of the FileNames component. These are the file name of the screen information file for English and the file name of the screen information file for Japanese.

The value of the version component is the version information of the profile. The version information may be only included in the management information corresponding to the profile.

The value of the ParentID component is ID of parent. When the management information corresponds to a group, the ID of the profile is the ID of parent. When the management information corresponds to a project, the group ID of the group to which the project belongs to is the ID of parent. When the management information corresponds to a profile, the ParentID component may be omitted.

The value of the ChildrenID is ID of child. When the management information corresponds to the profile, the ID of the group is the ID of child. When the management information corresponds to the group, the project ID of the project that belongs to the group is the ID of child. When the management information corresponds to the project, the ChildrenID component may be omitted.

Here, when the management information corresponding to the profile, the group or the project to be displayed is already generated (YES in S301), the process of step S302 is not performed.

Subsequently, the scan device application 125 generates a screen by referring to the management file corresponding to the one to be displayed (S303). For example, the management file includes the file name of the screen information file corresponding to the one to be displayed at the FileNames component. Thus, the scan device application 125 can easily specify the place where the necessary screen information file is stored based on the management file.

In other words, one of the functions of the management information stored in the management file is to enable in reducing the time necessary for specifying the place where a desired screen information file is stored. By using the management file, the speed necessary for searching the desired screen information file can be improved compared with a case in which the desired screen information file is searched by opening each of the screen information files every time. Here, the generated management file may be stored in a folder whose folder name is the profile ID of the profile, the group ID of the group or the project ID of the project corresponding to the management file. With this configuration, the speed for searching the management file corresponding to the one to be displayed can be improved.

Further, by making the management system of the screen information file to be adaptable to the device 10 side (scan device application 125), dependency on the management system at the service providing apparatus 20 can be lowered for the obtained screen information file. As a result, an influence to variation of the management system of the screen information file at the service providing apparatus 20 side can be made small.

Here, the management file generated for a single screen generation process is a management file corresponding to the one to be displayed. In other words, the management file is successively or sequentially generated in accordance with the variation of the screen to be displayed. For example, when the tab window to be displayed is changed, a management file is generated for the group of the tab window to be displayed. Further, when a button is pressed in the tab window, a management file is generated for the project of the button. By successively or sequentially generating the management file, lowering of the display speed in displaying the operation screen 810 for the first time can be prevented.

As described above, according to the embodiment, the screen information files are managed by differentiating the user dependence screen information files and the user independence screen information files. Before the user logs-in, in other words, before the user of the device 10 is specified, the user independence screen information file, that is not specified to any users, is downloaded to the device 10. On the other hand, after the user logs-in, in other words, after the user of the device 10 is specified, the screen information file that is the user dependence screen information file and is in correspondence with the specified user is downloaded to the device 10.

Thus, compared with the case that the screen information files of all the users are downloaded, the network load, amount of consumption of the HDD 114 or the like can be reduced. Thus, efficiency in obtaining the screen information file can be improved.

In particular, for the organization including a large number of employees, there is the possibility that the amount of the user dependence screen information files becomes larger than that of the user independence screen information files. For example, for the organization to which 10,000 employees belong to, there is a possibility that the screen information files of 10,000 are necessary. According to the embodiment, while enabling each of the employees to use a screen specific to the employee even when the employee uses any device, increase of the screen information files downloaded to each of the devices 10 can be suppressed.

Further, according to the embodiment, each of the devices 10 is associated with the language name (see FIG. 19), and the screen information file corresponding to the language name associated with the device 10 is downloaded to each of the devices 10. With this configuration, increase in the screen information files downloaded to each of the devices 10 can be suppressed.

The similar service may be actualized on image data stored in the storage device of the user environment E1. Further, the storage to store the image data may not be necessarily the online storage. For example, the storage may be a folder of the auxiliary storage device 202 of the service providing apparatus 20. Alternatively, the storage may be a folder of any storage device of the user environment E1.

Further, in this embodiment, an example of the Scan To Storage service in which the image data is input from the scanner and the image data is output to the storage is explained. However, the image data may be input by or output to other than the scanner or the storage, respectively. The image data may be input from a digital camera (including a mobile terminal or the like with a digital camera function), a whiteboard or the like. For the digital camera, the image data obtained by the digital camera is to be input. For the whiteboard, the image data obtained by reading the writing on the whiteboard is to be input.

The image data may be output to an image projecting apparatus such as a projector, a printer, conference system, a mobile terminal or the like.

Alternatively, as long as being capable of functioning as an input unit of the image data or an output unit of the image data, the service similar to that of the embodiment may be actualized by another device.

Further, electronic data other than the image data may be data to be input. For example, voice data recorded by an IC recorder, document data generated by a PC (Personal Computer) or the like may be data to be input.

As described above, as illustrated in FIG. 4, in addition to the device 10, a mobile terminal, a PC, a conference system, an image projecting apparatus, an IC recorder, another new device or the like may be connected to the service providing apparatus 20 via the network.

In such a case, the device information stored in the device information storing unit 232 may include information indicating the capability of the device. The information indicating the capability of the device means that, for example, information indicating functions of the device such as the device can scan, the device can output an image or the like. By including the information indicating the capability of the device in the device information, a functional unit that functions as a transferring unit of the image data may determine whether the device to output the data can output the image data by referring to the information, and transfer the image data to the device when the device is capable of outputting the image data. The device to output the data is, for example, a device that is designated as a device to output data in output destination cooperation information, which is a broader term of the storage cooperation information of the embodiment.

In this embodiment, the service providing apparatus 20 is an example of a data processing system. The scan server application 211 is an example of a first replying unit and a second replying unit. The scan device application 125 is an example of a first obtaining unit, a second obtaining unit and a display control unit. The HDD 114 is an example of a storing unit.

According to the embodiment, efficiency regarding obtaining screen information via a network can be improved.

Although a preferred embodiment of the data processing system, the device and the method of data processing has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

What is claimed is:

1. A data processing system connected to a device via a network, comprising:
a first replying unit that replies to the device, in response to an obtaining request of screen information from the device before a user is specified, with screen information that is not in correspondence with a specific user among a plurality of screen information that are in correspondence with identification information of the device; and
a second replying unit that replies to the device, in response to an obtaining request of screen information from the device after a user is specified, with screen information that is in correspondence with a specified user among the plurality of screen information that are in correspondence with the identification information of the device.

2. The data processing system according to claim 1,
wherein the first replying unit and the second replying unit replay with the screen information of a language name that is stored in correspondence with the device.

3. The data processing system according to claim 1,
wherein the first replying unit replies with the screen information when version information of the screen information included in the device and sent from the device and version information of the screen information stored in the data processing system are different.

4. A device connected to a data processing system via a network, comprising:
a first obtaining unit that obtains, before a user is specified, screen information that is not in correspondence with a specific user among a plurality of screen information that are in correspondence with identification information of the device from the data processing system;
a second obtaining unit that obtains, after a user is specified, screen information that is in correspondence with the specified user among the plurality of screen information that are in correspondence with the identification information of the device; and
a storing unit that stores the screen information obtained by the first obtaining unit or the second obtaining unit.

5. The device according to claim 4, further comprising:
a generation unit that generates management information indicating storing position of screen information to be displayed among the screen information stored in the storing unit; and
a display control unit that specifies the screen information to be displayed based on the management information, and displays a screen based on the screen information.

6. A method of data processing performed by a data processing system connected to a device via a network, comprising:
a first replying step of replying to the device, in response to an obtaining request of screen information from the device before a user is specified, with screen information that is not in correspondence with a specific user among a plurality of screen information that are in correspondence with identification information of the device; and
a second replying step of replying to the device, in response to an obtaining request of screen information from the device after a user is specified, with screen information that is in correspondence with a specified user among the plurality of screen information that are in correspondence with the identification information of the device.

7. The method of data processing according to claim 6,
wherein in the first replying step and the second replying step, the screen information of a language name that is stored in correspondence with the device is replied.

8. The method of data processing according to claim 6,
wherein in the first replying step, the screen information is replied when version information of the screen information included in the device and sent from the device and version information of the screen information stored in the data processing system are different.
